(19) United States
(12) Patent Application Publication
(10) Pub. No.: US 2024/0274945 A1
(43) Pub. Date: Aug. 15, 2024

(54) BATTERY PACK

(71) Applicant: BLACK & DECKER INC., New Britain, CT (US)

(72) Inventors: Mahmudul Bhuiyan, Centereach, NY (US); Abhisheka Moturu, Pikesville, MD (US); Timothy Hennesy, Baltimore, MD (US); Jason Dunthorn, Baltimore, MD (US); Michael Varipatis, Fallston, MD (US); Nicholas J. Garibaldi, Bel Air, MD (US); Luke R. Barton, Pontiac, MI (US); Moturu Abhisheka, Pikesville, MD (US); Michael W. Roberts, Red Lion, PA (US); John Palermo, Baltimore, MD (US); Steven Derby, Towson, MD (US)

(21) Appl. No.: 18/583,598

(22) Filed: Feb. 21, 2024

Related U.S. Application Data
(63) Continuation of application No. 17/157,464, filed on Jan. 25, 2021, now Pat. No. 11,923,557.
Application No. 17/157,464 is a continuation-in-part of application No. PCT/IB2019/000960, filed on Aug. 14, 2019.
(60) Provisional application No. 62/718,884, filed on Aug. 14, 2018.
(60) Provisional application No. 62/966,623, filed on Jan. 28, 2020.

(51) Int. Cl. H01M 50/24; H01M 50/247; H01M 50/284

(52) U.S. Cl. CPC H01M 50/24; H01M 50/247; H01M 50/284; H01M 2220/30

(57) ABSTRACT

A battery pack comprises a housing and a module holder. The module holder includes a plurality of core pack modules. Each module may have five sets of battery cells. The five sets of battery cells may be connected in series to each other. The core pack modules of the plurality of core pack modules are connected in series with each other.

### CROSS REFERENCE TO RELATED APPLICATION(S)

This application is a continuation of and claims priority to U.S. patent application Ser. No. 17/157,464 (“the '464 Application), filed Jan. 25, 2021, titled “Battery Pack” which in turn claims the benefit of priority under 35 U.S.C. § 120 to PCT/IB2019/000960 (“the '960 Application”), filed Aug. 14, 2019, entitled, “Power Tool System” which in turn claims the benefit of priority under 35 U.S.C. § 119(e) to U.S. Provisional Patent Application No. 62/718,884 (“the '884 Application”), filed Aug. 14, 2018, entitled, “Pass Through Terminal Design”, which are all incorporated herein by reference.

The '464 Application also claims priority under 35 U.S.C. § 119(e) to U.S. Provisional Patent Application No. 62/966,623, filed Jan. 28, 2020, titled “Battery Pack”, which is incorporated herein by reference.

### TECHNICAL FIELD

This application relates to a power tool system including a plurality of battery packs. In one implementation, the system includes at least one cordless power tool and at least two battery packs having the same rated voltage but with different capacities. This application relates to a battery pack and a method for manufacturing a battery pack. In one implementation, the battery pack includes a plurality of battery cells, a cell holder, and a printed circuit board coupled to the cell holder.

### BACKGROUND

A removable and rechargeable battery pack includes a housing. The housing holds and includes a plurality of battery cells. The housing may also include a mechanical interface for coupling to an associated electrical device such as a power tool. The interface typically includes a plurality of slots or openings that allows battery pack electrical terminals to mechanically and electrically mate with corresponding electrical device electrical terminals. The battery cells are held together, at least in part, by a battery cell holder and electrically coupled to the battery pack electrical terminals. The battery pack also includes a printed circuit board. The printed circuit board may be coupled to the battery cell holder, simply held against the battery cell holder or floating relative to the battery cell holder. The battery pack also includes a plurality of components coupled to the printed circuit board. It is not uncommon for moisture or debris such as metal shavings to enter the battery pack housing through the plurality of slots. The moisture or debris may come into contact with the one or more of the plurality of components on the printed circuit board. This may cause short circuits or other problems with the battery pack. As such, it is desirable to encapsulate or enclose the portions of the printed circuit board to protect the components from the moisture or debris.

In order to encapsulate or enclose portions of the printed circuit board, low pressure molded (LPM) material may be used. LPM material works best if the electronics and PCB are completely encapsulated and enclosed. LPM material does not reliably adhere to exposed edges or flat surfaces. If the LPM material is not adequately adhered to the printed circuit board moisture or debris may seep in between the LPM material and the printed circuit board. This may cause damage to certain electronic components (such as resistors, integrated circuit chips, capacitors, etc.) on the printed circuit board that are encapsulated and protected by the LPM material.

The instant application describes an example battery pack for protecting various encapsulated components on a printed circuit board from moisture or debris.

### SUMMARY

An aspect of the present application includes a battery cell holder with injection molded battery straps.

Another aspect of the present application includes a battery terminal with a punched bead that contacts a power tool terminal.

Another aspect of the present application includes a battery pack having a printed circuit board having drain holes within a footprint of a battery terminal for passing water and a cell holder beneath the printed circuit board that directs the water around the battery cells and out of the battery pack.

Another aspect of the present application includes a battery pack having a plurality of modular cores wherein each modular core includes a plurality of battery cells.

Another aspect of the present application includes power tool having a receptacle for receiving a battery pack wherein the receptacle includes a slot having a first dimension and a first battery pack having a battery pack housing having a first width dimension and a portion of a bottom wall of the first battery pack housing having a dimension parallel to the width dimension equal to the slot dimension that is received in the slot when the first battery pack is inserted into the battery pack receptacle and a second battery pack having a battery pack housing having a second width dimension that is greater than the first width dimension and a portion of a bottom wall of the second battery pack housing having a dimension parallel to the width dimension equal to the slot dimension that is received in the slot when the second battery pack is inserted into the battery pack receptacle.

An aspect of the present application includes a battery pack comprising a housing, a plurality of battery cells, a battery cell holder holding the plurality of battery cells, a printed circuit board, a plurality of components requiring exposure, the plurality of components affixed to the printed circuit board, a plurality of adhesion holes positioned to form a boundary about the plurality of components, a low pressure molded material applied to the printed circuit board such that the plurality of components are exposed and surrounded by the low pressure molded material; and the low pressure molded material having flowed through the plurality of adhesion holes.

Another aspect of the present application includes the printed circuit board and the low pressure molded material, wherein at least a portion of a boundary of the low pressure molded material is aligned with a subset of the plurality of adhesion holes.

Another aspect of the present application includes the printed circuit board and the low pressure molded material and the adhesion holes, wherein the adhesion holes have a diameter in a range of approximately 0.5 mm to approximately 2 mm.

Another aspect of the present application includes the printed circuit board and the low pressure molded material and the adhesion holes, wherein the adhesion holes have a diameter of approximately 1 mm.

Another aspect of the present application includes the printed circuit board and the low pressure molded material and the adhesion holes, wherein the distance between edges of adjacent adhesion holes is in a range of approximately 1 mm to approximately 3 mm.

Another aspect of the present application includes the printed circuit board and the low pressure molded material and the adhesion holes, wherein the distance between adjacent edges of adjacent adhesion holes is approximately 2 mm.

An aspect of the present application includes a battery pack comprising a housing, a plurality of battery cells, a battery holder holding the plurality of battery cells, a printed circuit board coupled to the battery holder, a plurality of elements associated with the printed circuit board, a plurality of adhesion holes positioned at least partially about the plurality of elements, a low pressure molded material applied to the printed circuit board such that the plurality of elements are exposed and the low pressure molded material flows through the plurality of adhesion holes.

Another aspect of the present application includes the printed circuit board and the low pressure molded material, wherein a subset of the plurality of adhesion holes are positioned along a portion of a boundary of the low pressure molded material.

Another aspect of the present application includes a battery pack. The battery pack comprises a module holder and a plurality of core pack modules held in the module holder.

Implementations of the foregoing aspects may include one or more of the following features.

In an aspect of the present patent application, the module holder may include a base and a set of opposing side walls that form an interior storage space that is configured to receive the plurality of core pack modules. The module holder may have a longitudinal axis along a length of the module holder, and a first transverse axis and a second transverse axis that are perpendicular to the longitudinal axis. The first transverse axis may be along a width of the module holder. The second transverse axis may be along a depth of the module holder. The set of opposing side walls may extend along the longitudinal axis of the module holder.

In an aspect of the present patent application, the base and the set of opposing side walls of the module holder may be integrally formed. The set of opposing side walls of the module holder may extend perpendicular to the base.

In an aspect of the present patent application, the set of opposing side walls may be a first set of opposing side walls. The module holder may further include a second set of opposing side walls. The second set of opposing side walls may extend along the first transverse axis of the module holder.

In an aspect of the present patent application, the base, the first set of opposing side walls, and the second set of opposing side walls may be integrally formed. The first set of opposing side walls and the second set of opposing side walls may extend perpendicular to the base.

In an aspect of the present patent application, each core pack module may include a plurality of battery cells. Each battery cell of the core pack module may extend along the second transverse axis of the module holder.

In an aspect of the present patent application, each core pack module may include a plurality of battery cells that are configured to be held in relative position to each other.

In an aspect of the present patent application, at least one of the plurality of core pack modules may be configured to be positioned to be parallel to the first transverse axis of the module holder.

In an aspect of the present patent application, the at least one the plurality of core pack modules may be configured to be positioned to be perpendicular to at least one other of the set of battery cell modules.

In an aspect of the present patent application, at least two of the plurality of core pack modules may be configured to be positioned to be parallel to each other.

In an aspect of the present patent application, the at least two of the plurality of core pack modules may be configured to be positioned to be parallel to the longitudinal axis of the module holder.

In an aspect of the present patent application, the battery pack further comprising a housing. The housing may include a first housing portion and a second housing portion together forming an internal cavity. The plurality of core pack modules may be received in the internal cavity of the housing.

In an aspect of the present patent application, one of the first housing portion and the second housing portion may form the module holder.

In an aspect of the present patent application, the plurality of core pack modules may include three core pack modules.

In an aspect of the present patent application, the battery pack may further comprise an electronics module subassembly configured to be positioned parallel to the base of the module holder, and a set of battery pack terminals fixedly held in place on the electronics module subassembly, the set of battery pack terminals configured to mate with a corresponding set of terminals of an electrical device. The electronics module subassembly may be configured to be connected with the plurality of core pack modules so as to electrically connect the plurality of core pack modules to the battery pack terminals.

In an aspect of the present patent application, the electronics module subassembly may be configured to be removably connected to portions of the plurality of core pack modules when the plurality of core pack modules are received in the interior storage space of the module holder.

In an aspect of the present patent application, the electronics module subassembly may include a printed circuit board.

In an aspect of the present patent application, each of the core pack modules of the plurality of core pack modules are identical. Each core pack module is a discrete assembly including a plurality of battery cells and a battery cell holder.

Another aspect of the present application includes a battery pack. The battery pack may include a plurality of core pack modules. Each module have five sets of battery cells. The five sets of battery cells may be connected in series to each other. The core pack modules of the plurality of core pack modules may be connected in series with each other.

Implementations of the foregoing aspects may include one or more of the following features.

In an aspect of the present patent application, each set of battery cells may contain at least one battery cell.

In an aspect of the present patent application, each set of battery cells may contain at least three battery cells.

In an aspect of the present patent application, the at least three battery cells of each set of battery cells may be connected in parallel.

In an aspect of the present patent application, the battery pack may further comprise a printed circuit board. Each core pack module of the plurality of core pack modules may be electrically connected in series to each other through the printed circuit board.

These and other aspects of the present patent application, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. In one embodiment of the present patent application, the structural components illustrated herein are drawn to scale. It is to be expressly understood, however, that the drawings are for the purpose of illustration and description only and are not intended as a definition of the limits of the present patent application. It shall also be appreciated that the features of one embodiment disclosed herein can be used in other embodiments disclosed herein. As used in the specification and in the claims, the singular form of “a”, “an”, and “the” include plural referents unless the context clearly dictates otherwise.

Other aspects, features, and advantages of the present patent application will become apparent from the following detailed description, the accompanying drawings, and the appended claims.

Each of the aspects described above and in the following description can be used in any combination of one or more of these aspects, as will be understood to one of ordinary skill in the art.

### BRIEF DESCRIPTION OF THE DRAWINGS

FIG. 1 is a top, front, left side isometric view of an example battery pack of the present application.

FIG. 2 is a top, rear, right side isometric view of the battery pack of FIG. 1.

FIG. 3 is a bottom, front, right side isometric view of the battery pack of FIG. 1.

FIG. 4 is a right side, elevation view of the battery pack of FIG. 1.

FIG. 5 is a top, plan view of the battery pack of FIG. 1.

FIG. 6 is a bottom, plan view of the battery pack of FIG. 1.

FIG. 7 is a front, elevation view of the battery pack of FIG. 1,

FIG. 8 is a rear, elevation view of the battery pack of FIG. 1.

FIG. 9 is a view of an example battery cell holder and a plurality of battery cells.

FIG. 10 is a view of a first subassembly of the cell holder of FIG. 9.

FIG. 11 is a view of the first subassembly and a second subassembly of the cell holder and the plurality of battery cells.

FIG. 12 is an isometric view of an example battery terminal of the present application.

FIG. 13 is an elevation view of the battery terminal of FIG. 12.

FIGS. 14A-14D are plan views of the battery terminal of FIG. 12 in various states of engagement with a power tool terminal.

FIG. 15 is a rear, right side isometric view of an example core pack of the present application.

FIG. 16 is a rear, left side isometric view of the core pack of FIG. 15.

FIG. 17 is a simplified schematic of the battery pack of FIG. 1 and an example power tool prior to mating.

FIG. 18 is a rear, right side isometric view of another example core pack of the present application.

FIG. 19 is a rear, left side isometric view of the core pack of FIG. 18.

FIG. 20 is an isometric view of an example printed circuit board of the present application.

FIG. 21 is a plan view of the printed circuit board of FIG. 20.

FIG. 22 is a section view of the printed circuit board of FIG. 21 and a portion of an example battery pack of the present application.

FIG. 23 is a top, front, left side isometric view of another example battery pack of the present application.

FIG. 24 is a top, rear, right side isometric view of the battery pack of FIG. 23.

FIG. 25 is a bottom, front, left side isometric view of the battery pack of FIG. 23,

FIG. 26 is a rear, elevation view of the battery pack of FIG. 23.

FIG. 27 is a top, plan view of the battery pack of FIG. 23.

FIG. 28 is a bottom, plan view of the battery pack of FIG. 23.

FIG. 29 is a view an example assembly process of the battery pack of FIG. 23.

FIG. 30 is a plan view of a plurality of modular core packs assembled in a lower housing of the battery pack of FIG. 23.

FIG. 31 is a plan view of printed circuit board assembled to the plurality of core packs of FIG. 30.

FIG. 32 is a side, elevation view of an example power tool for use with the battery packs of FIGS. 1 and 23.

FIG. 33 is an isometric view of the power tool of FIG. 32 in the direction of arrow A.

FIG. 34 is an isometric view of an example battery receptacle of the power tool of FIG. 32.

FIG. 35 is an elevation view of the battery receptacle of FIG. 34.

FIG. 36 is an elevation view of the battery pack of FIG. 1 in the battery receptacle of FIG. 34.

FIG. 37 is a section view of the battery pack of FIG. 23 in the battery receptacle of FIG. 34 along section line A-A of FIG. 32.

FIG. 38 is a view of the battery pack of FIG. 2 at detail A.

FIG. 39 is a partial isometric view of the battery pack of FIG. 2 and a partial section view of the receptacle of FIG. 34 along section line B-B of FIG. 36 just prior to coupling.

FIG. 40 is a partial isometric view of the battery pack of FIG. 2 and a partial section view of the receptacle of FIG. 34 along section line B-B of FIG. 36 fully coupled.

FIG. 41 is a section view of the battery pack of FIG. 2 in the battery receptacle of FIG. 34 along section line B-B of FIG. 36.

FIG. 42 is a view of the battery pack and receptacle of FIG. 41 at detail B.

FIG. 43 is an example of a battery pack in accordance with the present application.

FIG. 44 is an example of a printed circuit board in accordance with the present application.

FIG. 45 is an example of a top view of a battery pack in accordance with the present application with a top housing removed.

FIG. 46 is an isometric view of the battery pack of FIG. 45.

FIG. 47 is an isometric view of the printed circuit board and a plurality of battery cells of the present application.

### DETAILED DESCRIPTION

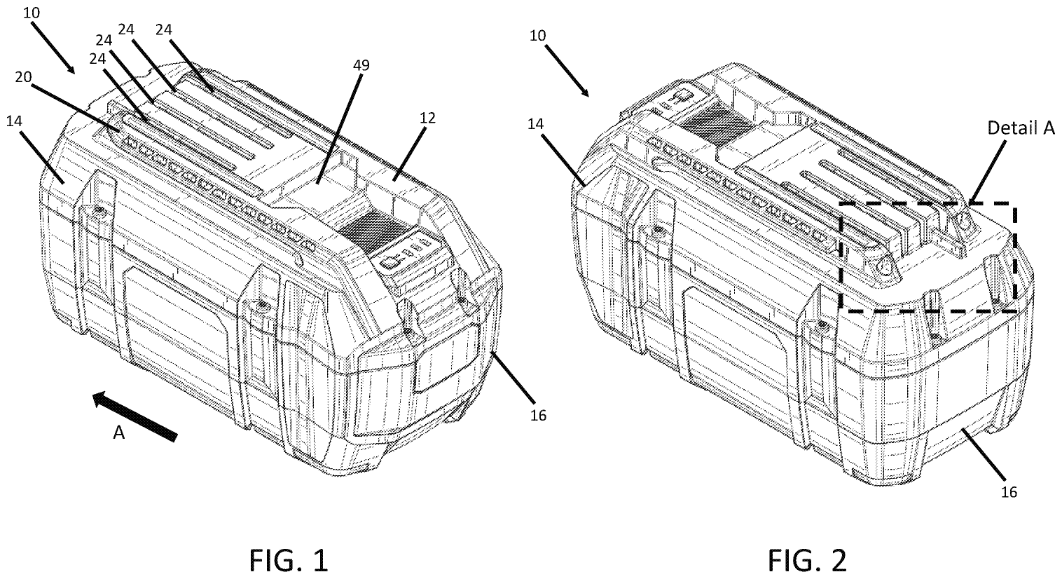

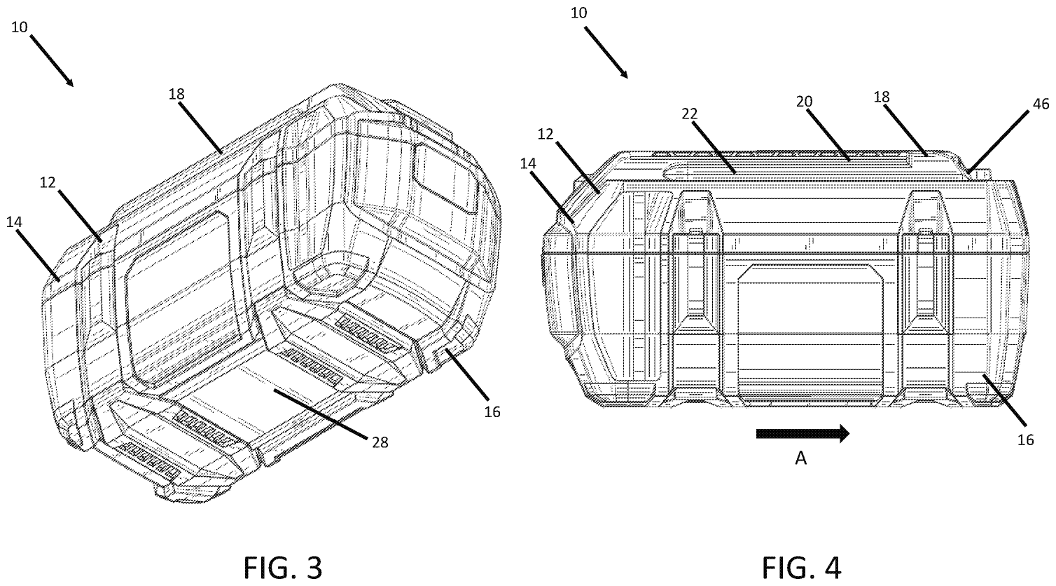

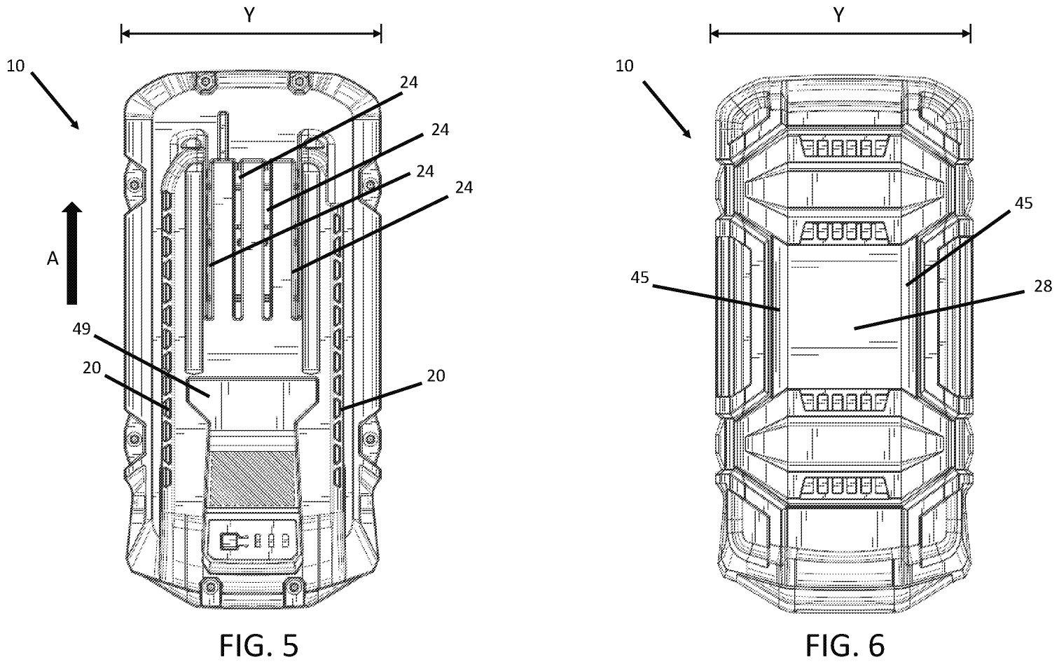

Referring to FIGS. 1 through 8, in an example embodiment, a first battery pack 10 includes a housing 12. The housing 12 includes an upper housing/portion 14 and a lower housing/portion 16. The upper housing 14 includes a mechanical interface 18 for mating and coupling with a power tool 200 having a corresponding mechanical interface 202. The battery pack mechanical interface 18 includes a pair of rails 20 and a pair of grooves 22. The grooves 22 receive a corresponding pair of rails 204 of the power tool 200. The battery pack mechanical interface 18 also includes a plurality of slots 24. The plurality of slots 24 are configured to receive a corresponding plurality (set) of power tool terminals 206 that mechanically and electrically mate with a corresponding plurality (set) of battery pack terminals 26, The plurality slots 24 define a plurality of parallel planes. The battery pack 10 is inserted into the power tool 200 in a direction parallel with the plurality of slots 24 and the plurality of parallel planes the insertion direction. The insertion direction is denoted by arrow A.

The first battery pack 10 has a width Y in a dimension perpendicular to the planes defined by the slots.

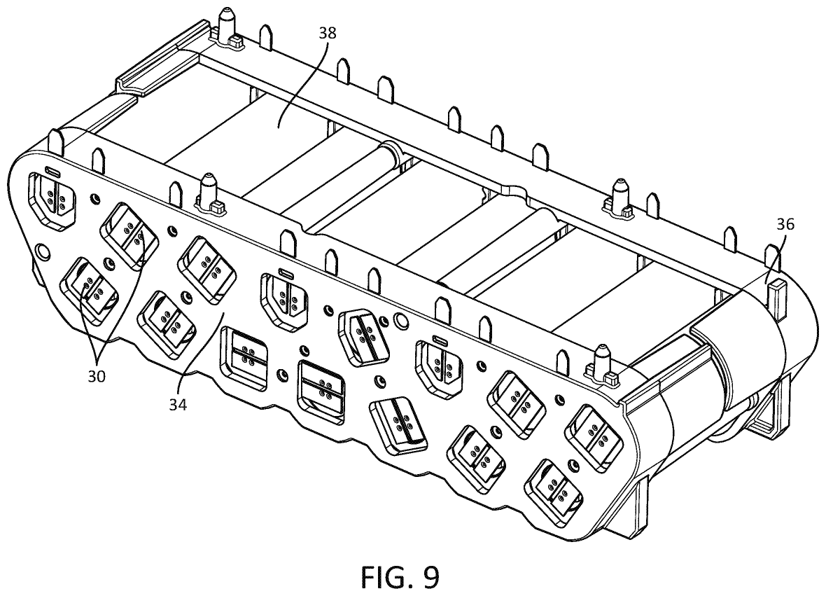

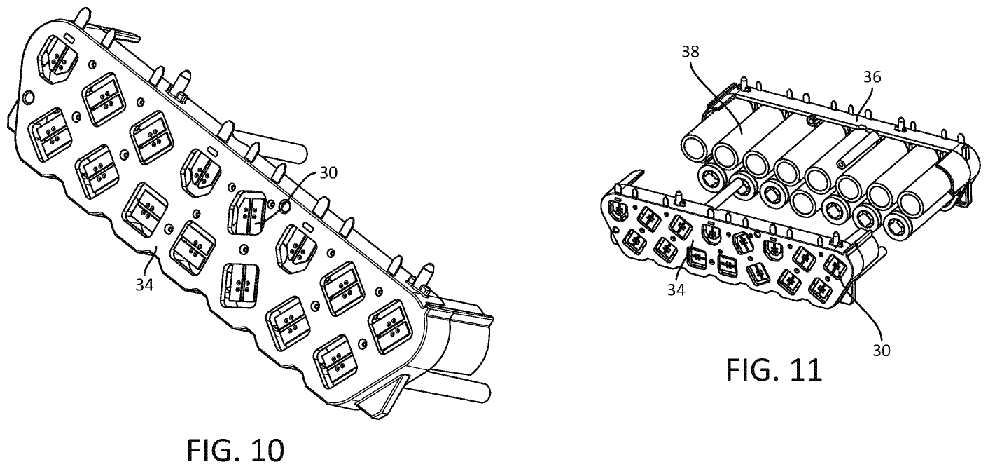

In order to connect a plurality of battery cells in a battery pack, a plurality of battery straps are applied to a cell holder. Applying these straps manually is a time consuming process and may lead to straps being applied to the wrong locations. This can be a safety concern. Referring to FIGS. 9 through 11, an example embodiment is illustrated in which a plurality (set) of battery cell straps 30 are insert molded in a cell holder 32, This eliminates the risk of incorrect straps being place in incorrect locations, saves time in assembly and provides a product with fewer contaminants. As illustrated in FIG. 11, the cell holder 32 may include two subassemblies 34, 36 (A and B). To generate each subassembly 34, 36, the set of battery straps 30 are placed in a mold. Plastic (or other suitable material) is injection molded into the mold around the set of battery straps 30. The two cell holder subassemblies 34, 36 are then assembled with a plurality of battery cells 38 resulting in a cell holder/cell subassembly 32. The straps 30 may then be welded to the battery cells 38.

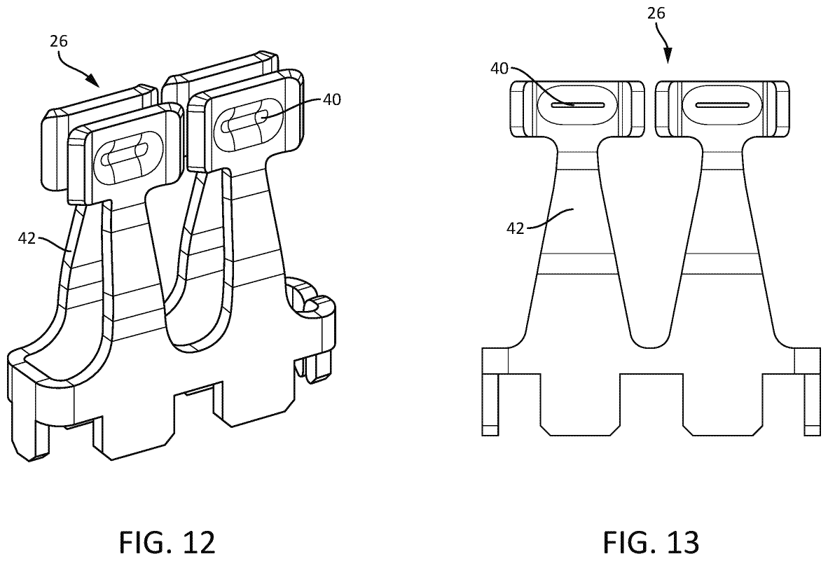

Referring to FIGS. 12, 13, 14A, 14B, 14C, and 14D, there is illustrated an example battery terminal 26. As illustrated, contact points of the battery terminals 26 are beads 40 that are formed by a punch instead of a bend. The tool blade (terminal) 206 is perpendicular to spring arms 42 of the battery terminal 26. The springs arms 42 are completely independent to one another. The battery terminals 26 are mounted directly to a PCB 44 and then soldered. As such, no terminal block is needed. This configuration provides a large cross section that allows the battery terminal 26 to run cooler at higher current draw.

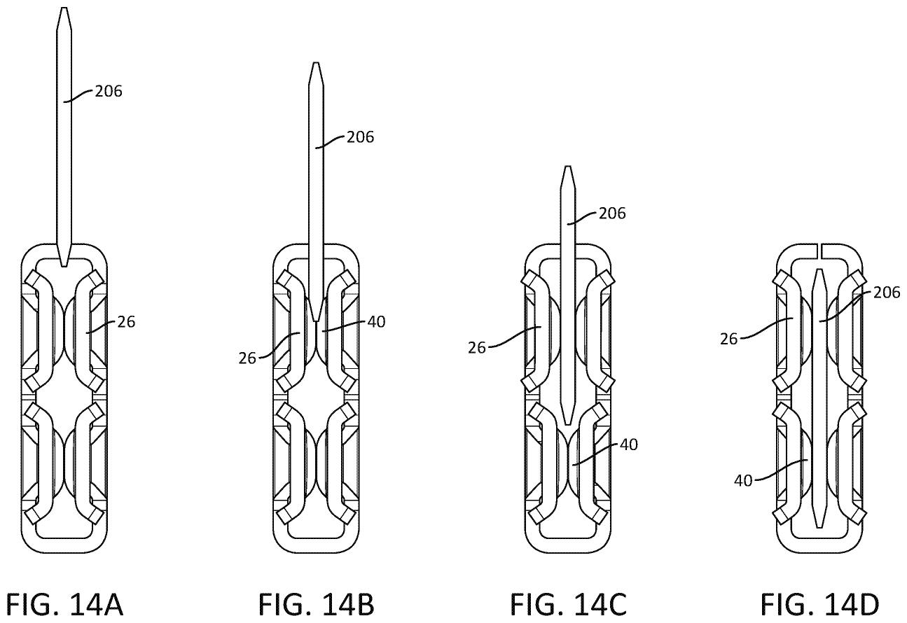

As illustrated in FIGS. 14A through 14D, the first part of the battery terminal 26 that makes contact with the tool terminal 206 is the bead 40 of the battery terminal 26.

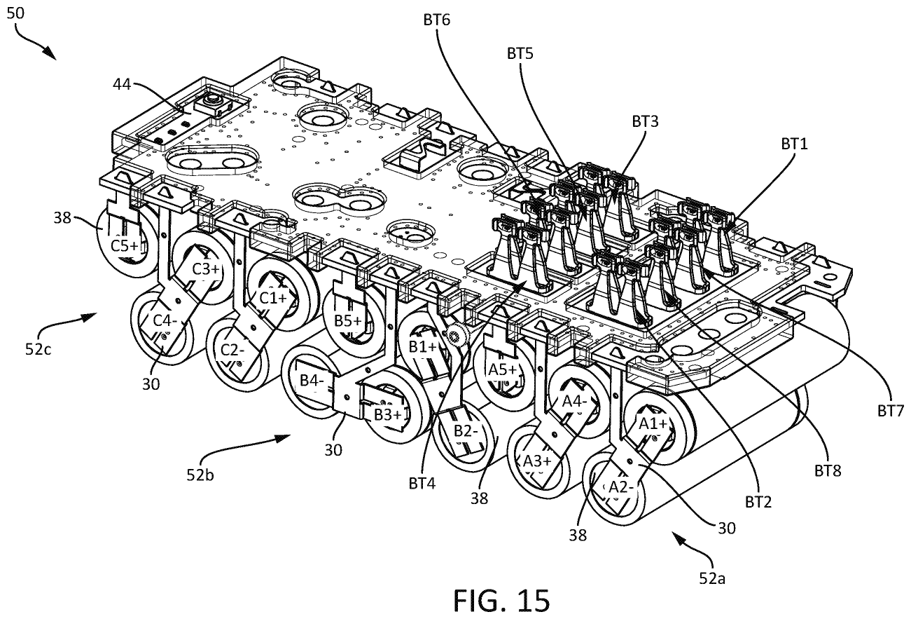

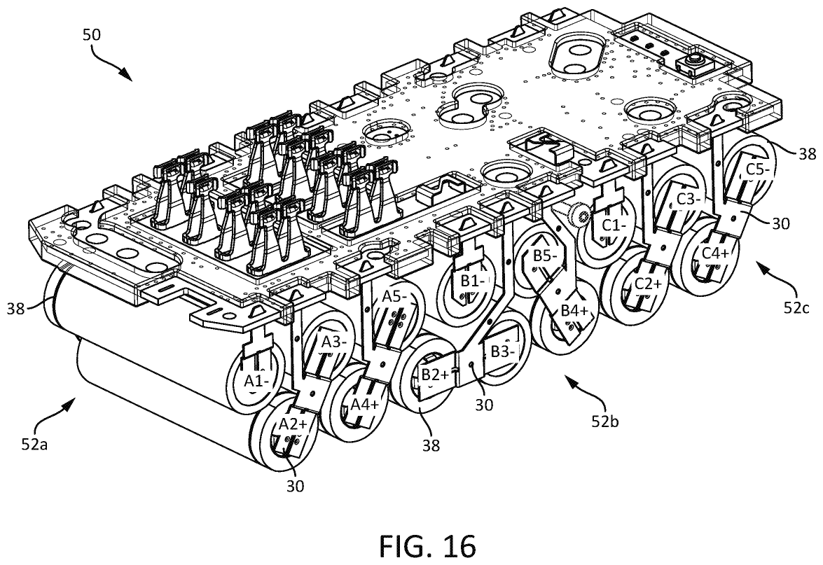

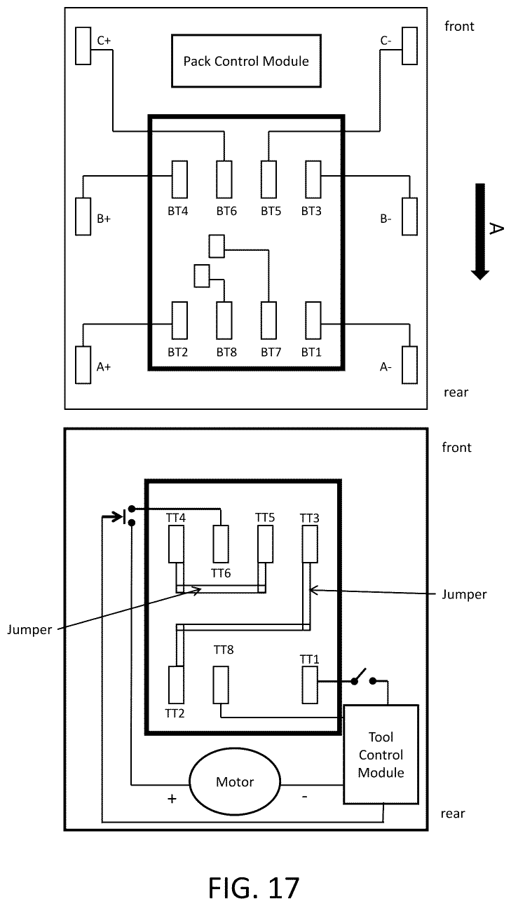

FIGS. 15 and 16 illustrate a first example embodiment of a core pack 50 of the first battery pack 10, In this embodiment, the core pack 50—and therefore the battery pack 10 includes fifteen battery cells 38. The battery cells 38 are configured in three sets of five cells—an A set 52a, a B set 52b and a C set 52c. The five cells 38 in each set 52a, 52b, 52c are connected in series and the three sets 52a, 52b, 52c are connected in series—when coupled to a power tool 200. Each set 52a, 52b, 52c is referred to as 5S1P-five cells in series.

The sets of cells 52a, 52b, 52c are configured to minimize the amount of space required. Specifically, each the cells 38 of each set 52a, 52b, 52c are positioned relative to each other the same way but the B set 52b is rotated about an axis in the center of the set that is parallel to a longitudinal axis of the battery cells 38. Furthermore, the A set 52a and the C set 52c have the same orientation. As such, the B set 52b is sandwiched between the A set 52a and the C set 52c to minimize the space the cells 38 require in a direction perpendicular to the longitudinal axis of the battery cells and in a direction parallel to the insertion direction.

In other words, each set of cells 52a, 52b, 52c includes three cells 30 adjacent to each other and aligned with their longitudinal axes in a first plane and two cells 30 adjacent to each other and aligned with their longitudinal axes in a second plane that is parallel to the first plane. Furthermore, adjacent sets of cells 52a, 52b, 52c are arranged such that the first plane of the first set 52a is in the same plane as the second plane of the second set 52b and the second plane of the first set 52a is in the same plane as the first plane of the second set 52b.

Specifically, the first plane of the A set 52a is in the same plane as the second plane of the B set 52b and the second plane of the A set 52a is in the same plane as the first plane of the B set 52b. The same is true of the B set 52b and the C set 52c. This provides a particularly compact core pack 50—and battery pack 10—in the insertion direction.

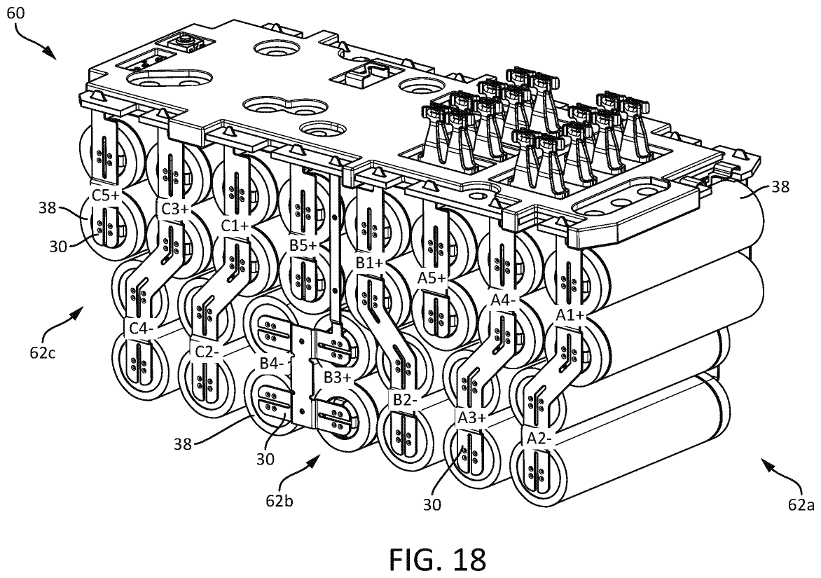

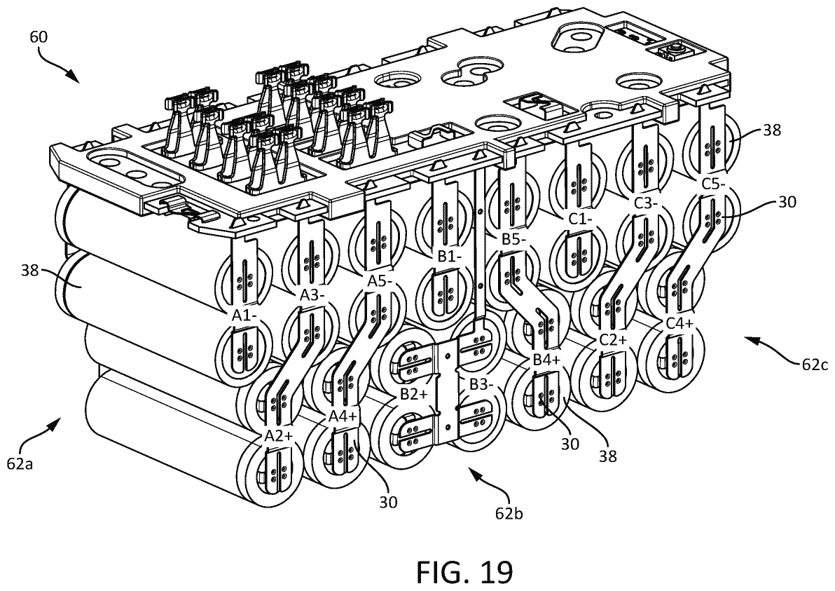

Referring to FIGS. 18 and 19, another example embodiment of a core pack 60 is illustrated. In this embodiment, there are still three sets of battery cells 62a, 62b, 62c and the three sets 62a, 62b, 62c are connected in series, however each set 62a, 62b, 62c includes ten battery cells 30, In this embodiment, in each set of battery cells 62a, 62b, 62c there are five subsets of two battery cells 30 wherein the two battery cells 30 of each subset are connected in parallel and the five subsets are connected in series. This results in the same voltage as the previous embodiment but with twice the capacity assuming the same battery cells in each embodiment. In this embodiment, each set 62a, 62b, 62c is referred to as 5S2P five subsets in series with each subset having two battery cells 30 in parallel.

Again, the sets of battery cells 62a, 62b, 62c are arranged to minimize the space in the dimension in the insertion direction, similar to the previous embodiment.

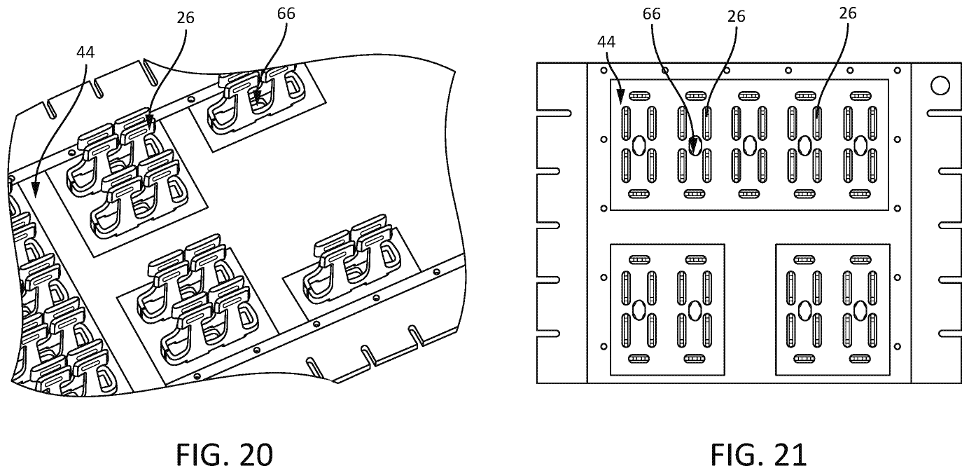

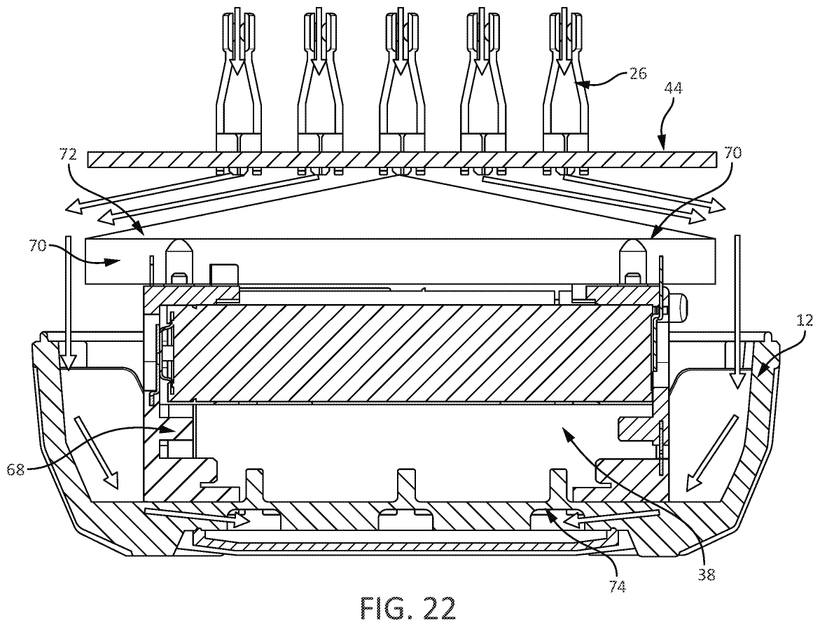

Referring to FIGS. 20 through 22, there is illustrated an example embodiment for distributing and removing water that gets into the battery pack housing 12, As illustrated in FIGS. 20 and 21, a plurality of battery terminals 26 are attached to a printed circuit board 44, The printed circuit board 44 includes a hole 66 located within a footprint of the terminal 26. This would allow any trapped water to pass through the PCB 44 down onto the cell holder 68, FIG. 22 illustrates a path-indicated by the arrows-the water would take after it passes through the PCB 44. The battery pack 10 would include a cell holder 68 having a top or cap 70 having slanted surfaces 72. After the water passes through the PCB 44 it would run down the slanted surfaces 72 of the cell holder cap 70. The water would then flow down to interior sides of the pack housing 12 and then out of drain holes 74 in a bottom wall 76 of the battery pack housing 12.

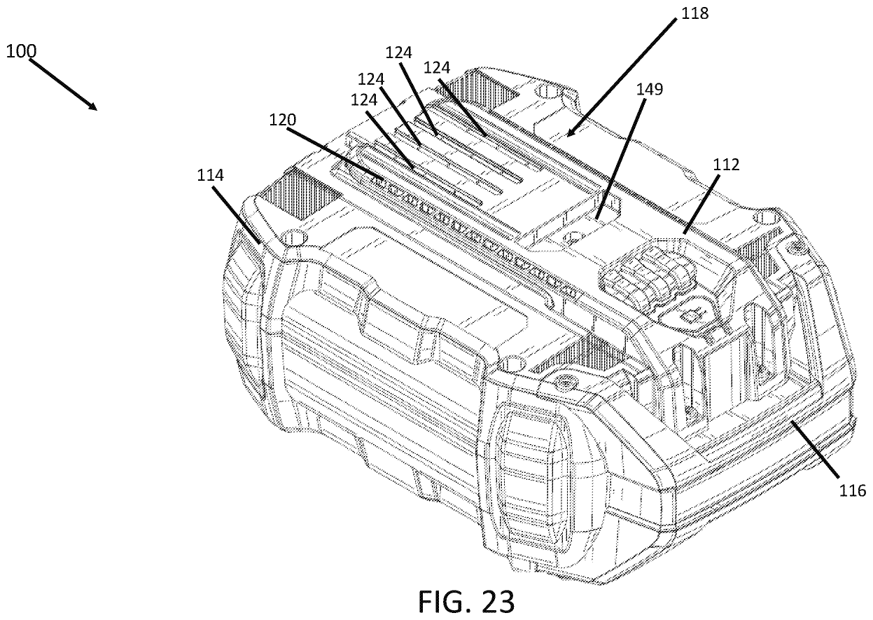

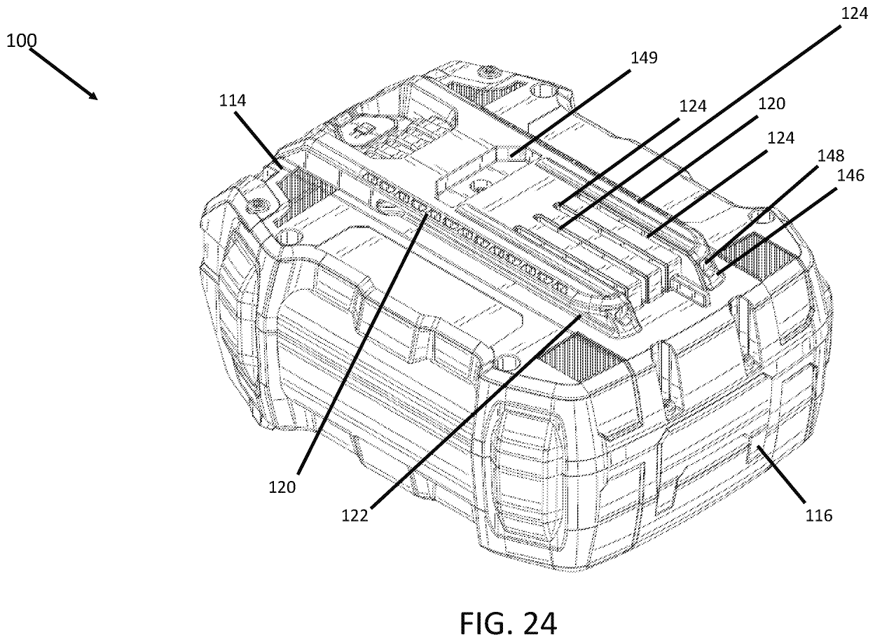

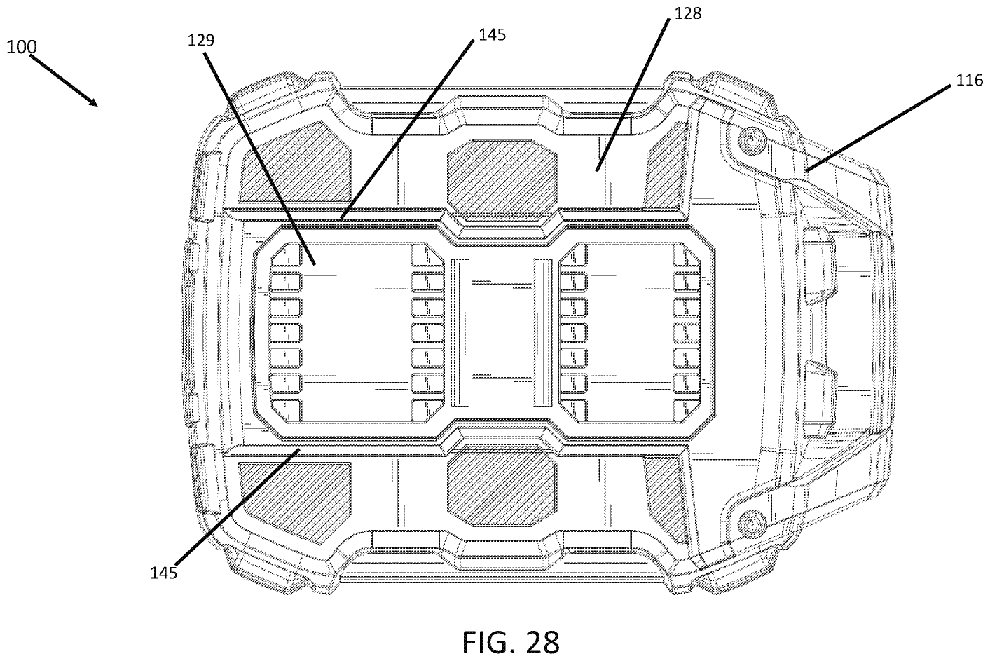

Referring to FIGS. 23 through 28, an example embodiment of a second battery pack 110 is illustrated. The second battery pack 110 includes a mechanical interface 118 virtually identical to the mechanical interface 18 of the first battery pack 10. As such, the second battery pack 110 will be able to mate with the same power tools 200 as the first battery pack 10—unless the manufacture desires to prevent the second battery pack 10 from mating with tools 200 that the first battery pack 10 is intended to mate (or vice versa) in which case the mechanical interface 18/118 of one or the other of the battery packs 10/110 may include some type of lockout. As noted above, the second battery pack 100 includes a plurality of slots 124 to receive the power tool terminals 206. These slots 124 define a plurality of parallel planes. The second battery pack 110 has a width Z in a dimension perpendicular to the planes defined by the slots 124. This width Z is greater than the width Y of the first battery pack 10. Yet due to both battery packs 10/110 having the same mechanical interface 18/118, both battery packs 10/110 are capable of mating and operating with the same power tools 200.

As such, there may be a power tool system including at least one power tool 200 having a plurality of terminals 206, a first battery pack 10 having a mechanical interface 18 for mating with the at least one power tool 200, the mechanical interface 18 of the first battery pack 10 including a plurality of slots 24 for receiving the plurality of power tool terminals 206, the plurality of slots 24 of the first battery pack 10 defining a plurality of parallel planes, the first battery pack 10 having a housing 12, the first battery pack housing 12 having a width dimension in a direction perpendicular to the planes defined by the plurality of slots 24, and a second battery pack 110 having a mechanical interface 118 for mating with the at least one power tool 200, the mechanical interface 118 of the second battery pack 110 including a plurality of slots 124 for receiving the plurality of power tool terminals 206, the plurality of slots 124 of the second battery pack 110 defining a plurality of parallel planes, the second battery pack 110 having a housing 112, the second battery pack housing 112 having a width dimension Z in a direction perpendicular to the planes defined by the plurality of slots 124, wherein the width dimension Z of the second battery pack 100 is greater than the width dimension Y of the first battery pack 100. In one embodiment, the width dimension Z of the second battery pack 100 is at least 1.5 times the width dimension Y of the first battery pack 10.

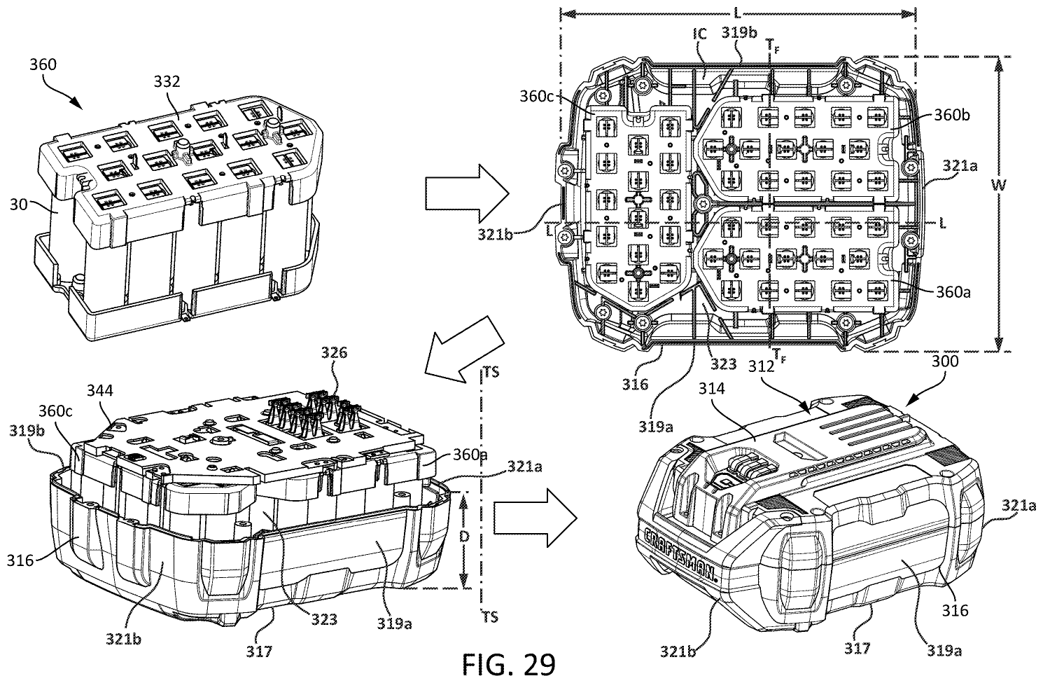

FIGS. 29, 30 and 31 illustrate a third example battery pack 300 having a modular core pack 360. In this example embodiment, the third battery pack 300 includes a plurality of core pack modules 360a, 360b, 360c. Each module 360a, 360b, 360c includes a plurality of battery cells 30 held in relative position to each other by a cell holder 332.

In an example embodiment, the second battery pack 300 is a 60-volt rated battery pack having a relatively high capacity (Amp-hour rating). To achieve this voltage and capacity, the battery pack 300 includes forty-five battery cells 30.

When using so many battery cells in a battery pack 300 is not unheard of to have one or more of the battery cells 30 fail or become unfit during the manufacture and assembly of the cells 30 and/or the pack 300. In this instance, if all forty-five cells were assembled into a single core pack and if a single cell of that single core pack were to be found unusable the entire core pack of forty-five cells would need to be thrown away—resulting in a significant waste of materials.

In order reduce waste associated with placing so many cells 30 into a battery pack 300, a modular approach has been taken. In this approach, in this example embodiment, each module 360a, 360b, 360c includes fifteen four-volt cells 30. Each module 360a, 360b, 360c includes five sets of three four-volt cells 30 wherein the three four-volt cells 30 are connected in parallel and the five sets are connected in series. As such, each set of cells is rated at four volts and each module is rated at twenty (20) volts. The three modules 360a, 360b, 360c are connected in series through connections to and through the printed circuit board 344 resulting in a sixty (60) volt rated battery pack.

In this approach, if a cell 30 of a particular module 360a, 360b, 360c is found to be unfit, then the single module can be removed wasting only fifteen cells-instead of wasting the entire forty-five cells.

As illustrated in FIG. 29, the modular cores 360a, 360b, 360c are assembled in a first step. The battery cells 30 of the module are tested. If any of the battery cells 30 are found to be unfit in a particular module that particular module is thrown away. Three of the modules 360a, 360b, 360c are placed in a lower housing/portion 316 of the battery pack housing 312. A printed circuit assembled board 344 is with the plurality of modules 360a, 360b, 360c to electrically connect the modules 360a, 360b, 360c to the battery pack terminals 326. The upper housing/portion 314 of the battery pack housing 312 may then be coupled to the lower housing/portion 316 of the battery pack housing 312 to complete the battery pack 300.

Referring to FIGS. 29, 30 and 31, the battery pack 300 may comprise the housing 312. The lower housing/portion 316 of the housing 312 may serve as the module holder 316. The module holder 316 may hold the plurality of core pack modules 360.

The module holder 316 may include a base 317 and a set of opposing side walls 319a, 319b that form an interior storage space 323 that is configured to receive the plurality of core pack modules 360. The module holder 316 may have a longitudinal axis L-L along a length L of the module holder 316. The module holder 316 may also have a first transverse axis T_{F}-T_{F} and a second transverse axis Tₛ-Tₛ that are perpendicular to the longitudinal axis L-L. The first transverse axis T_{F}-T_{F} may be along a width W of the module holder 316. The second transverse axis Tₛ-Tₛ may be along a depth D of the module holder 316. The set of opposing side walls 319a, 319b may extend along the longitudinal axis L-L of the module holder 316.

The base 317 and the set of opposing side walls 319a, 319b of the module holder 316 may be integrally formed. The set of opposing side walls 319a, 319b of the module holder 316 may extend perpendicular to the base 317.

The set of opposing side walls 319a, 319b may be a first set of opposing side walls 319a, 319b. The module holder 316 may further include a second set of opposing side walls 321a, 321b. The second set of opposing side walls 321a, 321b may extend along the first transverse axis T_{F}-T_{F} of the module holder 316.

The base 317, the first set of opposing side walls 319a, 319b, and the second set of opposing side walls 321a, 321b may be integrally formed. The first set of opposing side walls 319a, 319b and the second set of opposing side walls 321a, 321b may extend perpendicular to the base 317.

Each core pack module 360a, 360b, 360c may include a plurality of battery cells 30. Each battery cell 30 of each core pack module 360a, 360b, 360c may extend along the second transverse axis Tₛ-Tₛ of the module holder 316. Portions of each battery cell 30 and/or portions of each core pack module 360a, 360b, 360c may extend (along the second transverse axis Tₛ-Tₛ) beyond the depth D of the module holder 316. The portions of each battery cell 30 and/or portions of each core pack module 360a, 360b, 360c may extend outwardly and away from (the base 317 of) the module holder 316. The portions of each battery cell 30 and/or portions of each core pack module 360a, 360b, 360c may be received in an interior storage space of the upper housing 314 when the upper housing 314 and the lower housing/module holder 316 are connected to each other.

Each core pack module 360a, 360b, 360c may include a plurality of battery cells 30 that are configured to be held in relative position to each other. For example, each core pack module 360a, 360b, 360c may include a cell holder 332 and a plurality of battery cells 30 that are held in relative position to each other by the cell holder 332.

At least one core pack module 360c of the plurality of core pack modules 360 may be configured to be positioned to be parallel to the first transverse axis T_{F}-T_{F} of the module holder 316. The at least one core pack module 360c of the plurality of core pack modules 360 may be configured to be positioned to be perpendicular to at least one other 360a, 360b of the plurality of core pack modules 360.

At least two core pack modules 360a, 360b of the plurality of core pack modules 360 may be configured to be positioned to be parallel to each other. The at least two core pack modules 360a, 360b of the plurality of core pack modules 360 may be configured to be positioned to be parallel to the longitudinal axis L-L of the module holder 316.

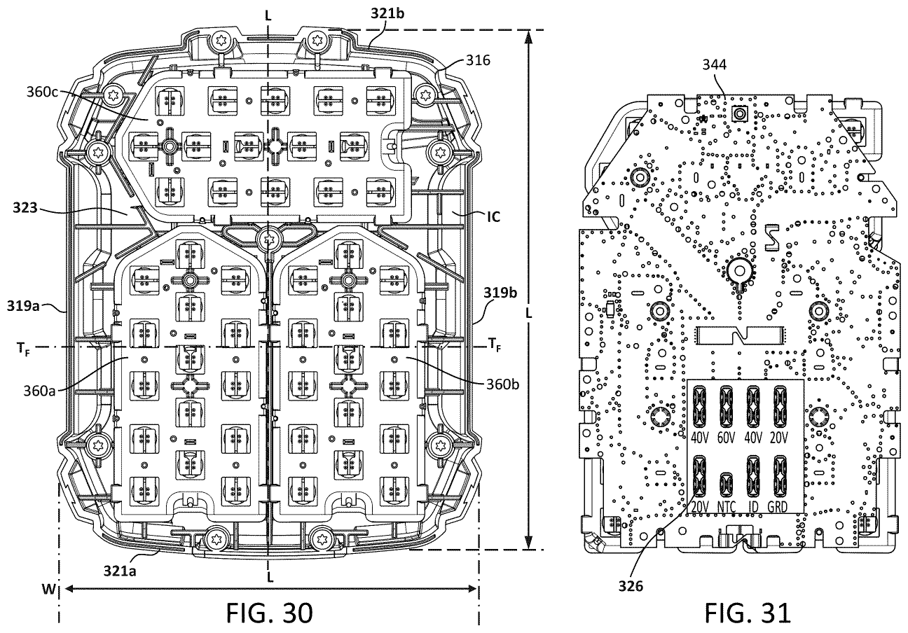

Positioning of the plurality of core pack modules 360 in the module holder 316 may vary (e.g., based on the application). In the illustrated embodiment, the bases of the core pack modules 360a, 360b are positioned adjacent to the side wall 321a of the module holder 316 and the top portions of the core pack modules 360a, 360b are positioned adjacent a first side wall of the core pack module 360c. The second side wall of the core pack module 360c is positioned adjacent to the side wall 321b of the module holder 316. In this embodiment, the core pack module 360c may be reversed such that the top portions of the core pack modules 360a, 360b may be positioned adjacent the second side wall of the core pack module 360c and the first side wall of the core pack module 360c is positioned adjacent to the side wall 321b of the module holder 316. Similarly, one or both of the core pack modules 360a, 360b may be reversed from their illustrated positions shown in FIGS. 29 and 30. In another embodiment, the bases of the core pack modules 360a, 360b may be positioned adjacent to the side wall 321b of the module holder 316 and the top portions of the core pack modules 360a, 360b may be positioned adjacent to either the first side wall or a second side wall of the core pack module 360c. The first or second side wall of the core pack module 360c may be positioned adjacent to the side wall 321a of the module holder 316. In yet another embodiment, as would be appreciated by a person of ordinary skill in the art, all the core pack modules 360a, 360b, 360c may be parallel to each other. These are just a few examples. Other positioning configurations of the core pack modules 360a, 360b, 360c in the interior storage space 323 of the module holder 316 may be appreciated by a person of ordinary skill in the art. Each of the core pack modules 360a, 360b, 360c of the plurality of core pack modules 360a, 360b, 360c are identical. Each core pack module 360a, 360b, 360c is a discrete assembly including the plurality of battery cells 50 and a battery cell holder.

In some embodiments, the interior storage space 323 of the module holder 316 may have structures (e.g., ribs) therein that may be configured to help retain the core pack modules 360a, 360b, 360c in position relative to the module holder 316 when the core pack modules 360a, 360b, 360c are positioned in the interior storage space 323 of the module holder 316. These structures may be removably attached to the module holder 316. These structures may be integrally formed with the module holder 316. These structures may be optional. The positioning of these structures may be modified to match with the positioning of the core pack modules 360a, 360b, 360c in the interior storage space 323 of the module holder 316.

In the illustrated embodiment, the bases of the core pack modules 360a, 360b, 360c and the top portions of the core pack modules 360a, 360b, 360c may have different shapes/configurations. In another embodiment, the bases of the core pack modules 360a, 360b, 360c and the top portions of the core pack modules 360a, 360b, 360c may have the same shape/configuration. For example, the base of each core pack module 360a, 360b, 360c and the top portion of each core pack module 360a, 360b, 360c may have straight shape/configuration and may be parallel to each other.

The housing 312 may include the first housing portion 314 and the second housing portion 316 together forming an internal cavity IC. The plurality of core pack modules 360 may be received in the internal cavity IC of the housing 312. One of the first housing portion 314 and the second housing portion 316 may form the module holder 316.

The plurality of core pack modules 360 may include three battery cell modules 360a, 360b, 360c.

The battery pack 300 may further comprise the electronics module subassembly 344 configured to be positioned parallel to the base 317 of the module holder 316, and a set of battery pack terminals 326 fixedly held in place on the electronics module subassembly, the set of battery pack terminals configured to mate with a corresponding set of terminals of an electrical device. The electronics module subassembly may be configured to be connected with the plurality of core pack modules so as to electrically connect the plurality of core pack modules to the battery pack terminals.

As shown in FIGS. 29 and 31, the electronics module subassembly 344 may be configured to be removably connected to portions of the plurality of core pack modules 360 when the plurality of core pack modules 360 are received in the interior storage space 323 of the module holder 316. The electronics module subassembly 344 may include the printed circuit board 344. The positioning of the electronics module subassembly/printed circuit board 344 may be modified/changed to match with the positioning of the battery cell modules 360a, 360b, 360c in the interior storage space 323 of the module holder 316.

The battery pack 300 may include the plurality of core pack modules 360. Each module 360a, 360b, 360c may have five sets of battery cells 30. The five sets of battery cells 30 may be connected in series to each other. The battery cell modules 360a, 360b, 360c of the plurality of core pack modules 360 are connected in series with each other.

Each set of battery cells 30 may contain at least one battery cell 30. Each set of battery cells 30 may contain at least three battery cells 30. The at least three battery cells 30 of each set of battery cells 30 may be connected in parallel.

The battery pack 300 may further comprise the printed circuit board 344. Each battery cell module 360a, 360b, 360c of the plurality of core pack modules 360 may be electrically connected in series to each other through the printed circuit board 344.

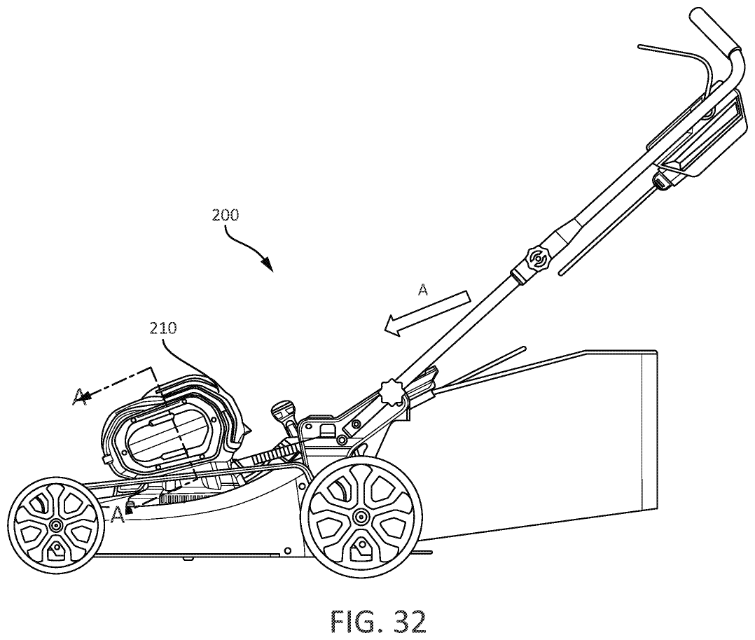

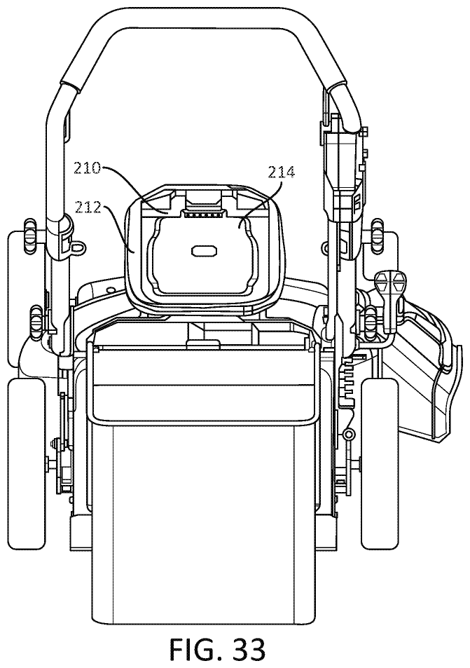

FIGS. 32 and 33 illustrate an example power tool 200 that may be powered by either of the first example battery pack 10, the second example battery pack 100 or the third example battery pack 300. In this instance, the example power tool 200 is a lawn mower. However, other power tools may also be configured to utilize the battery packs 10/100/300, for example, chain saws. The lawn mower 200 includes a receptacle 210 for receiving the battery packs 10/100/300—referred to as a battery pack receptacle 210.

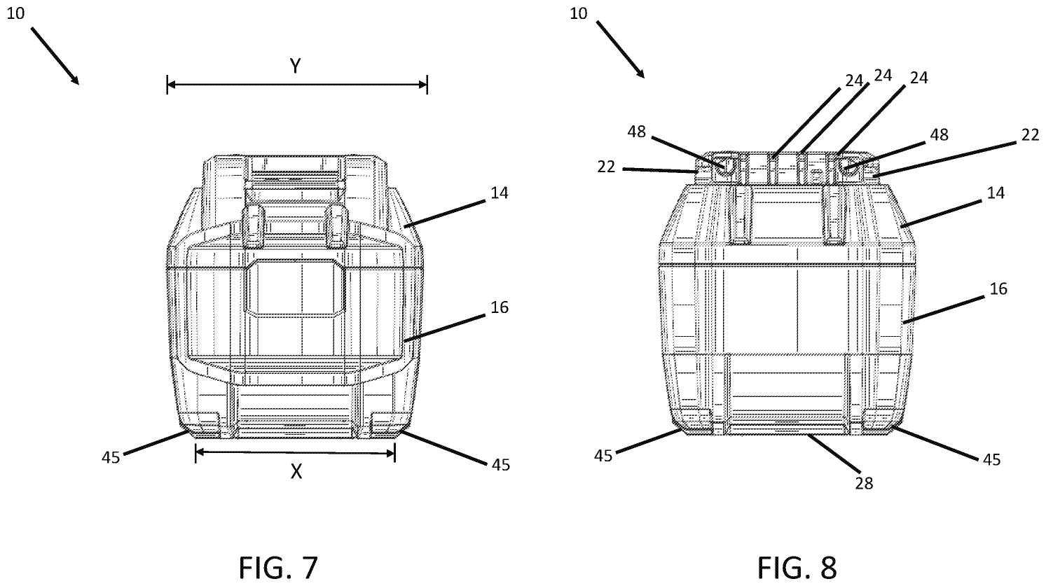

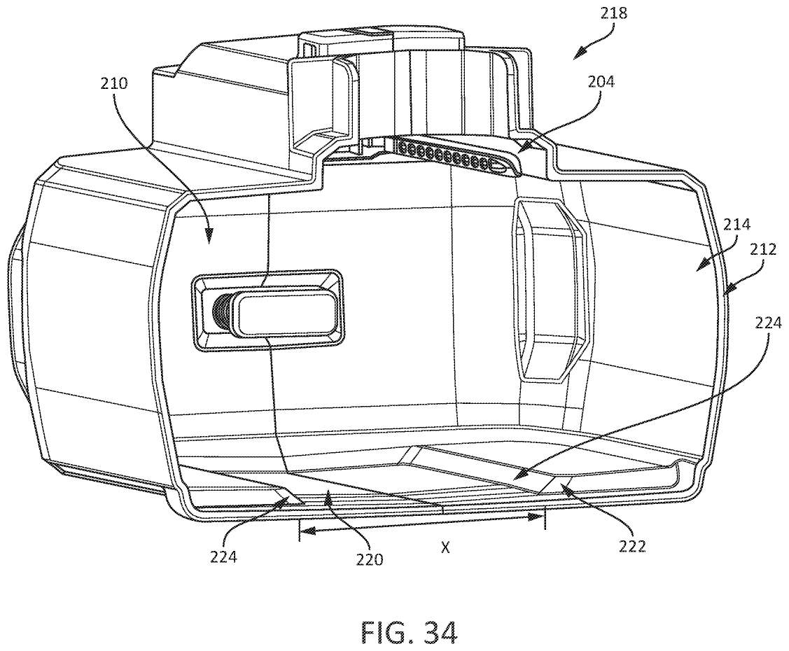

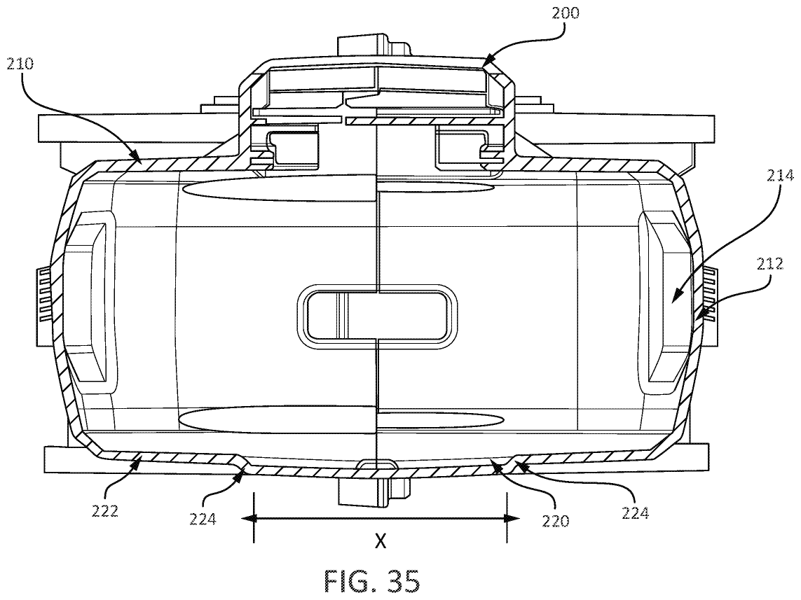

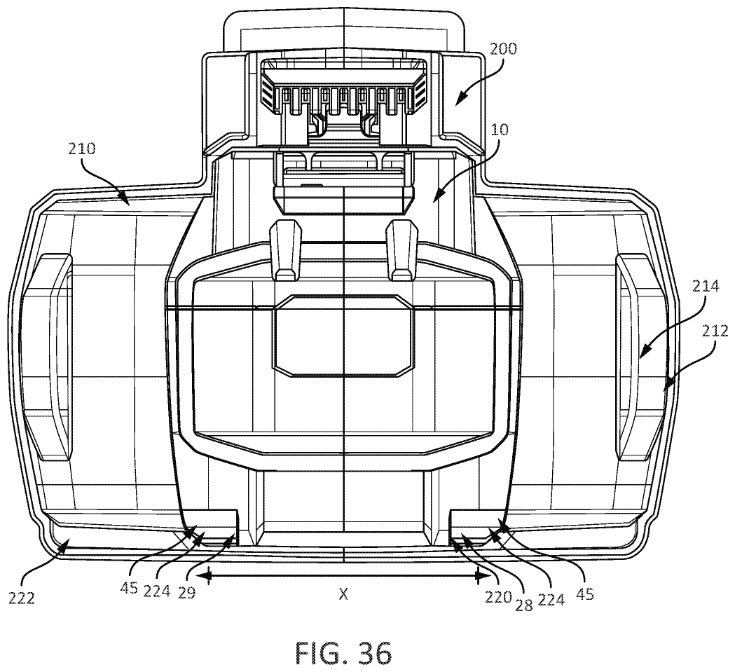

As illustrated in detail in FIGS. 34 and 35, the battery pack receptacle 210 includes a housing 212 defining a cavity/volume 214 for receiving the battery packs 10/100, The battery pack receptacle 210 includes a mechanical interface 218 for mating with the battery pack mechanical interface 18/118. The battery pack receptacle interface 218 (also referred to as a tool mechanical interface) includes a set of rails (tool rails) 204 that are received in the battery pack grooves 22/122. The battery pack receptacle mechanical interface 218 also includes a slot 220 in a wall 222 of the housing 212 opposed to the tool rails 204. The slot 220 has a dimension (width) X. In a preferred embodiment the slot 220 includes angled side walls 224. The dimension X of the slot 220 is equal to a dimension of a bottom wall 28 of the housing 12 of the first battery pack 10 of FIGS. 1 through 8. As illustrated in FIG. 7, the bottom wall 28 of the housing 12 (opposed to the portion of the housing 12 including the battery pack mechanical interface 18) may also include angled walls 45 to correspond with the angled walls 224 of the slot 220 of the battery pack receptacle 210. As illustrated in FIG. 36, when the first battery pack 10 is inserted into the battery pack receptacle 210 and mated with the power tool 200, the bottom wall 28 of the first battery pack 10 is received in the slot 220. As such, the slot 220 assists in holding the first battery pack 10 in place relative to the battery pack receptacle housing 210.

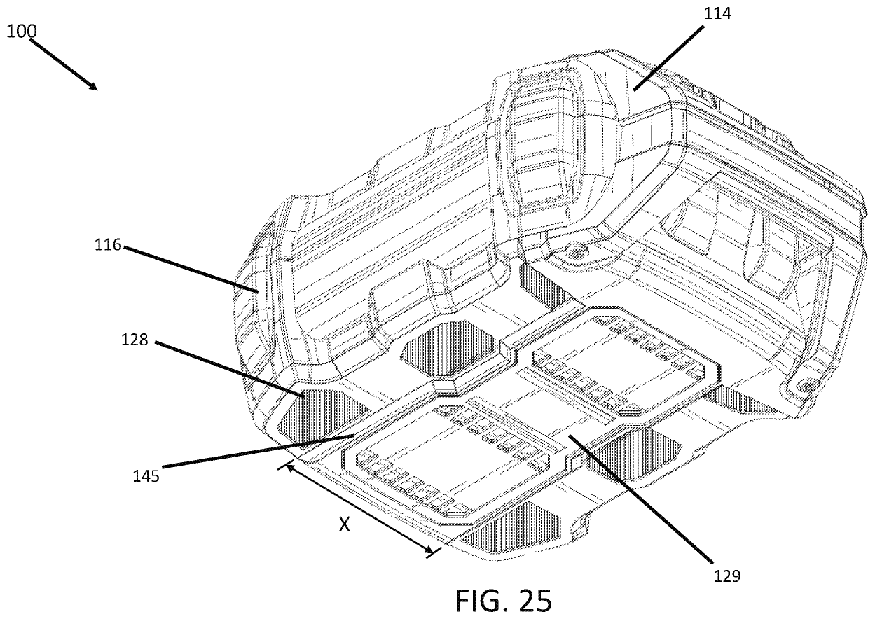

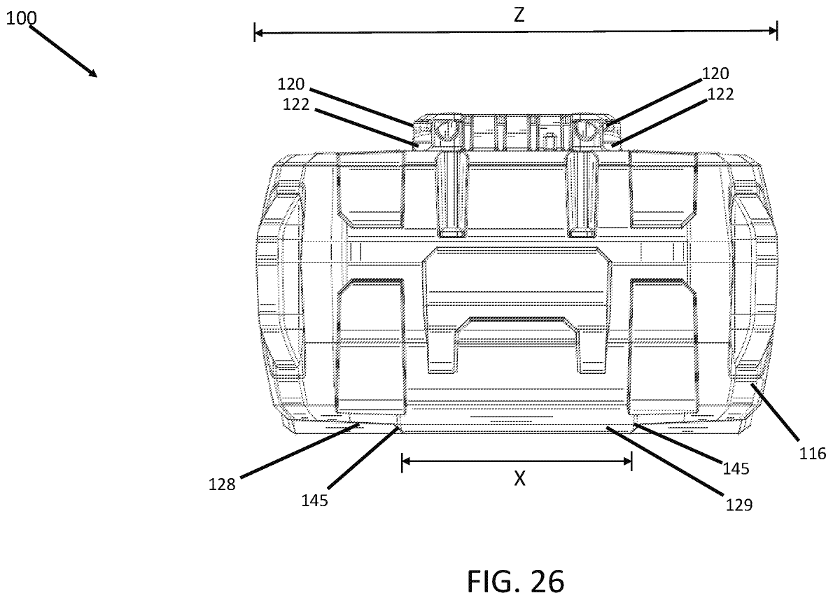

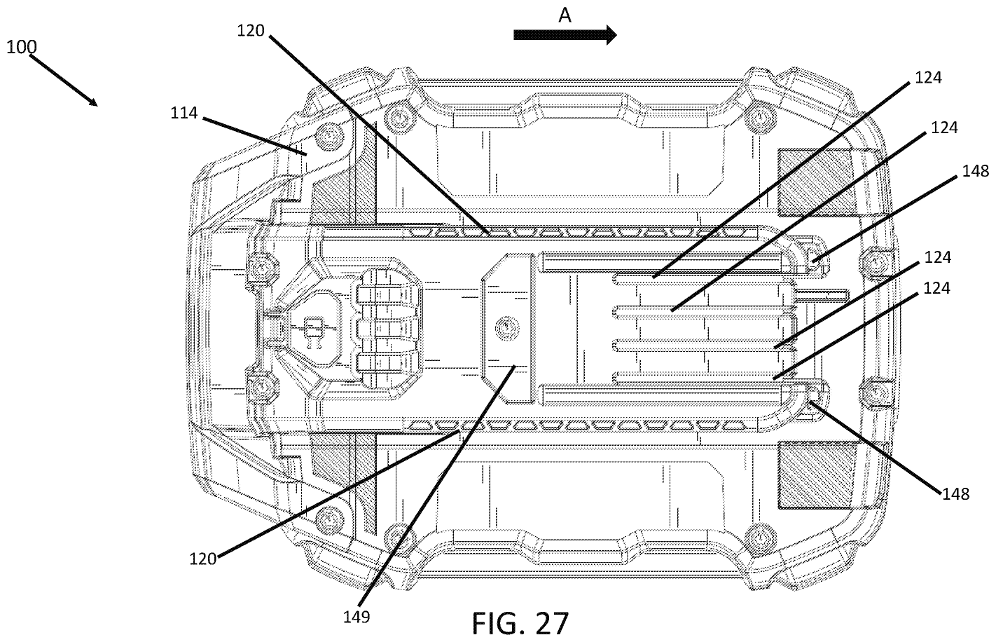

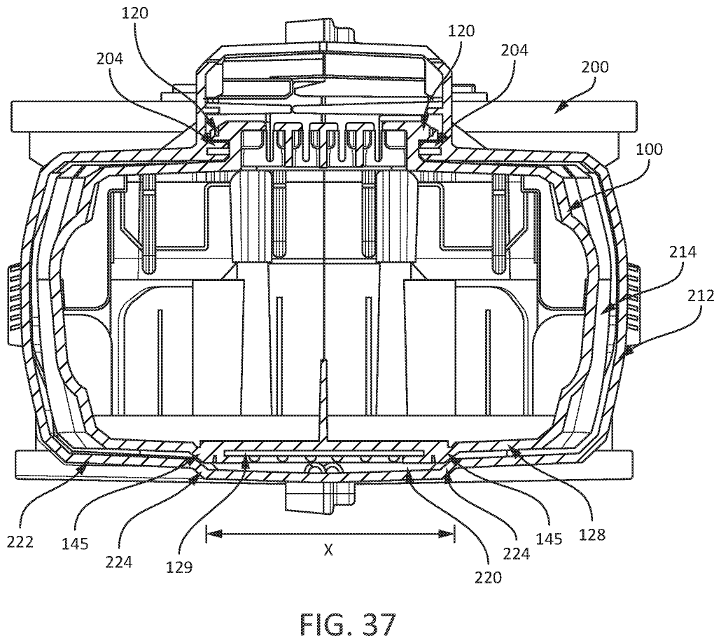

The second battery pack 100 illustrated in FIGS. 23 through 28 also includes a projected portion 129 of a bottom wall 128 of the battery pack housing 112. The projected portion 129 has a dimension X (as illustrated in FIGS. 25 and 26). The projected portion 129 may also include angled walls 145 to correspond with the angled wall 224 of the slot 220 of the battery pack receptacle 210. As illustrated in FIG. 37, when the second battery pack 100 is inserted into the battery pack receptacle 210 and mated with the power tool 200, the projected portion 129 of the bottom wall 126 of the second battery pack 100 is received in the slot 220. As such, the slot 220 assists in holding the second battery pack 100 in place relative to the battery pack receptacle housing 212.

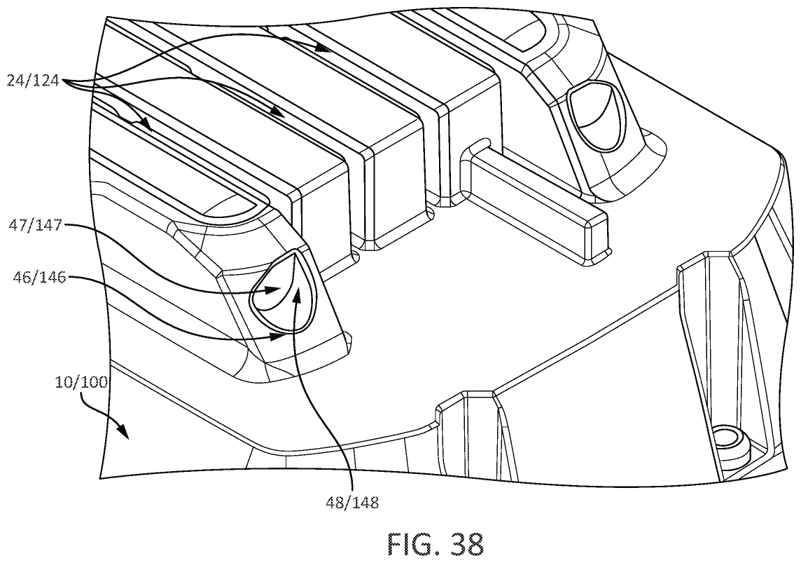

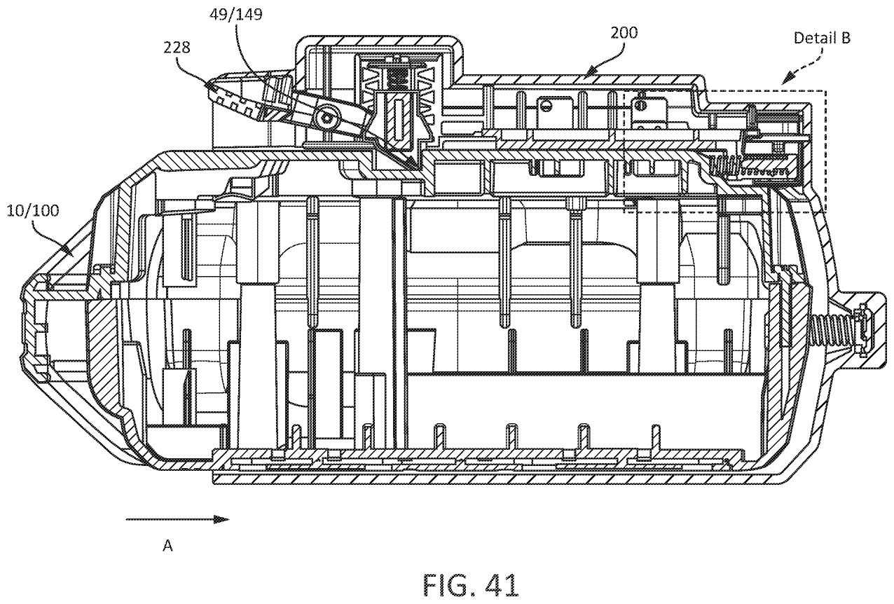

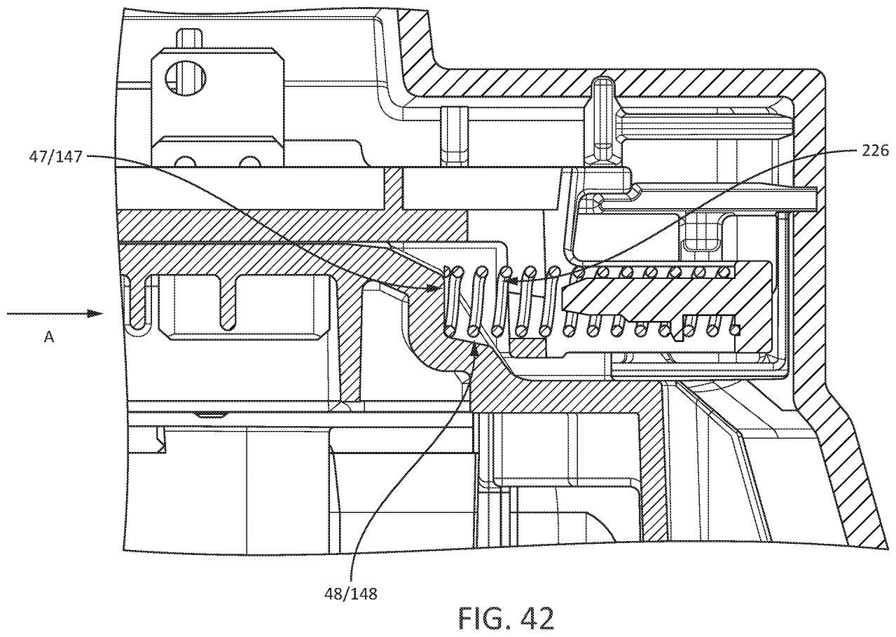

Referring to FIGS. 38 through 42, in another example embodiment, the first and second battery packs 10/100 may include features to address the increased weight resulting from larger and more powerful battery pack systems. To ensure that large battery packs with weights up to and over ten pounds and their mechanical interfaces 18/118—particularly the rails 20/120—are not susceptible to cracking, the strength of rail system is significantly increased by adding a second sloped wall 46/146 at the mating face of the mechanical interface 18/118, In order to assist in removing the battery pack 10/100 from the power tool 200, a spring 226 may be included in the power tool 200 to force the battery pack 10/100 out of the battery pack receptacle 210 when a latch 228 on the power tool 200 is released.

However, with the presence of the sloped wall 46/146, in order for the springs 226 to properly operate, the springs 226 require a flat engagement or contact surface 47/147 as well as a spring receptacle 48/148 to trap the spring 226 so it stays in line with the flat engagement surface 47/147. The spring receptacle 48/148 is preferably of a size and shape to be concentric with the spring 226, Providing small circular flat surfaces on the sloped front face keeps most of the sloped front wall 46/146 to ensure strength while the flat portion 47/147 of the spring receptacle 48/148 provides a contact surface for the springs 226. The material remaining around the spring receptacle 48148 serves as a guide and trap for the spring 226.

As illustrated in FIG. 38, in one embodiment the battery pack 10/100 includes a pair of sloped walls 46/146 at the mating end. Each sloped wall 46/146 may include a spring receptacle 48/148 for receiving a spring 226 of the power tool 200. The spring receptacle 48/148 may have a semi-cylindrical shape that is dimensioned to be concentric with the power tool spring 226. The spring receptacle 48/148 may include a spring engagement surface 47/147 perpendicular to the mating direction. The spring engagement surface 47/147 will engage with the spring 226 when the battery pack 10/100 mates with the power tool 200.

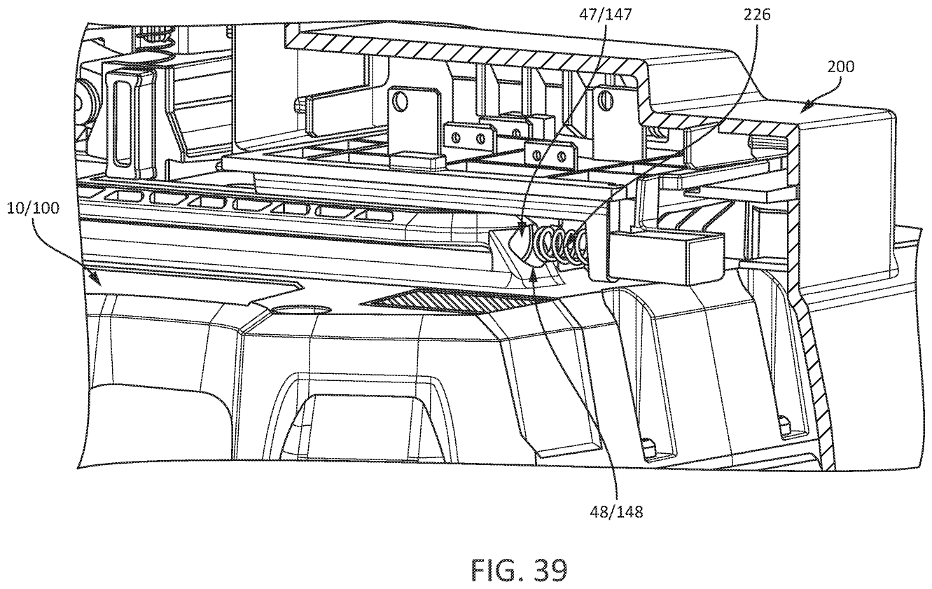

As illustrated in FIG. 39, the power tool 200 may include a pair of springs 226 (only one is shown in FIG. 39). Prior to engaging with the battery pack 10/100 the spring 226 is in its uncompressed state. As the battery pack 10/100 is inserted to the power tool 200 and the power tool rails 204 are received in the battery pack grooves 22/122, the spring 226 will be aligned with the spring receptacle 48/148.

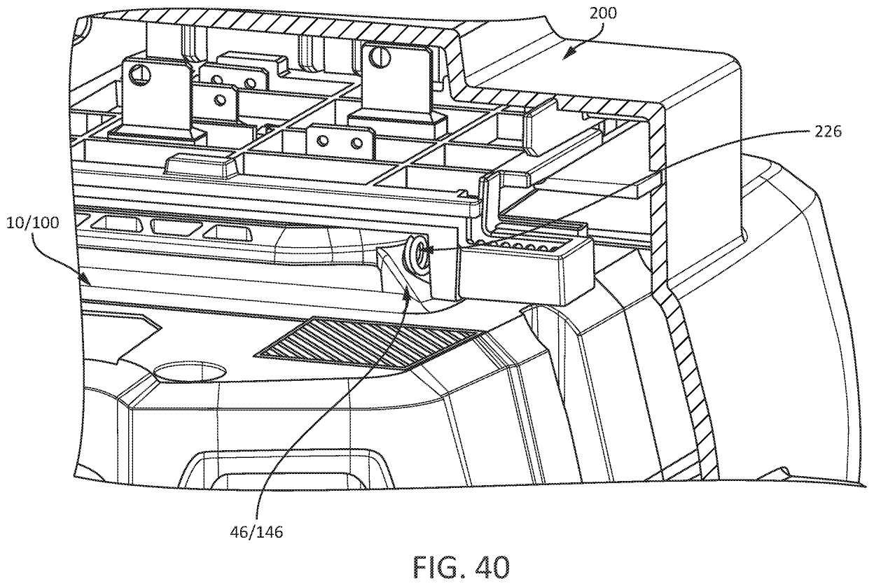

As illustrated in FIGS. 40, 41, and 42, when the battery pack 10/100 is fully mated with the power tool 200 the spring 226 will be fully compressed. The latch 228 on the power tool 200 will be received in a catch 49/149 of the battery pack 10/100 to hold the battery pack 10/100 fully engaged/mated with the power tool 200. When the latch 228 is operated by a user to release the battery pack 10/100, the springs 226 will force the battery pack 10/100 (at least partially) out of the battery pack receptacle 210.

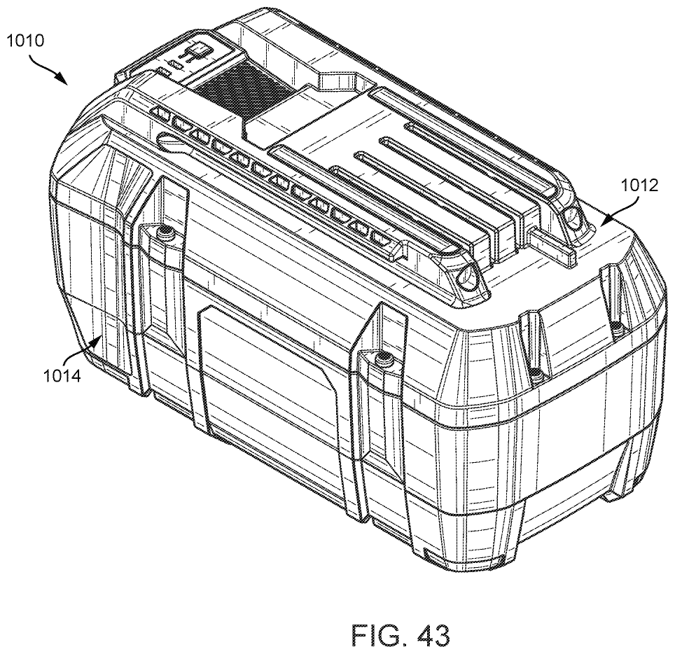

Referring to FIG. 43, in an example embodiment, a battery pack 1010 includes an upper housing 1012 and a lower housing 1014 coupled to the upper housing 1012. The battery pack 1010 includes a plurality of battery cells 1015 and a battery cell holder 1017 holding the plurality of battery cells 1015. The battery pack 1010 includes a mechanical interface for coupling to an associated electrical device (not shown), for example a power tool or a battery charger. The interface includes a plurality of slots for providing access to a plurality of battery pack terminals 1022 (described in more detail below). The slots allow for ingress of moisture and debris.

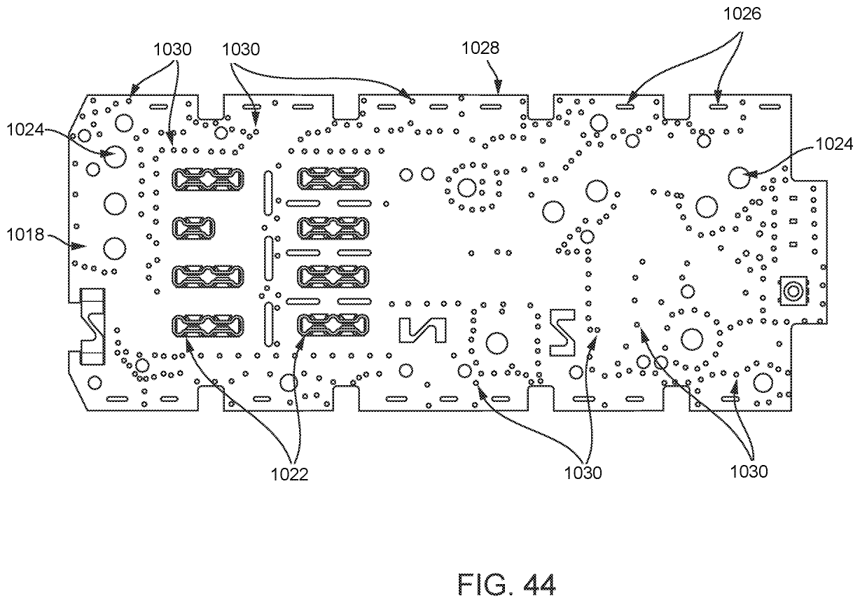

Referring to FIG. 44, there is illustrated an example of a printed circuit board 1018 in accordance with the present application. The printed circuit board 1018 may include a plurality of electronic components, such as processors, resistors and capacitors (not shown) that are susceptible to damage if contacted by moisture or debris. As such, it is desirable to encapsulate and enclose these components with LPM material 1020. There are other components or features on the printed circuit board 1018, such as battery pack terminals 1022, test points 1024, and battery strap holes 1026, that must be accessible to couple or mate with other components. As such, these components and features cannot be encapsulated with LPM material 1020. This results in boundaries of the LPM material 1020 between components that are encapsulated and components/features that are not encapsulated.

As noted above, the LPM material 1020 does not adhere well to the printed circuit board 1018 exposed edges 1028 or flat surfaces. To address this shortcoming, the printed circuit board 1018 includes a plurality or array of adhesion holes 1030. The adhesion holes 1030 are positioned at the boundaries of the LPM material 1020. The adhesion holes 1030 enable the LPM material 1020 to flow through the printed circuit board 1018. As a result, the LPM material 1020 wraps around the printed circuit board 1018 providing improved adhesion to the printed circuit board 1018.

As illustrated in FIG. 44, the adhesion holes 1030 are positioned, for example, around a plurality of battery strap holes 1026. Each of the plurality of battery strap holes 1026 receive an end of a battery strap 1032. The adhesion holes 1030 are also positioned, for example, around the plurality of battery pack terminals 1022. The adhesion holes 1030 are also positioned, for example, around the plurality of test points 1024 and the fuses 1034.

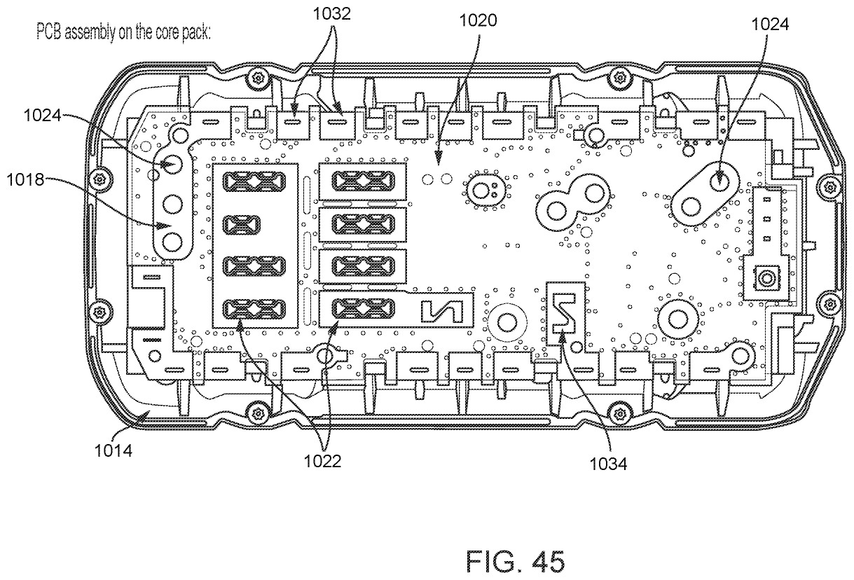

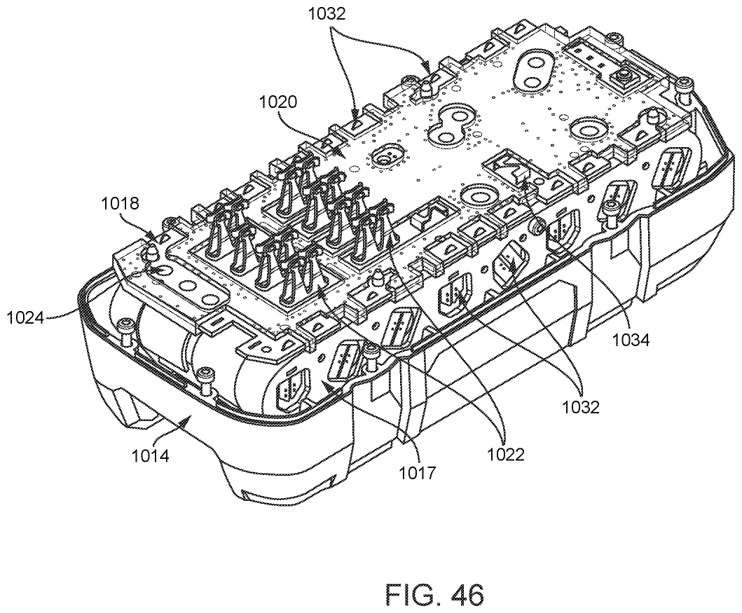

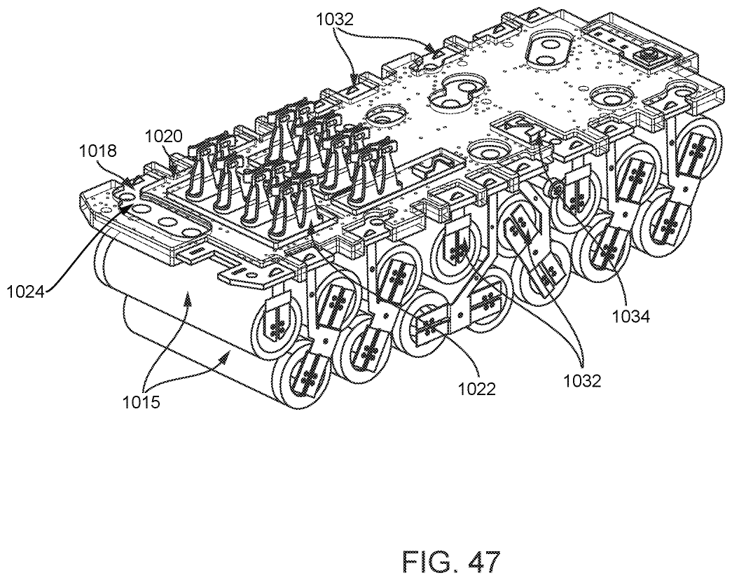

FIGS. 45, 46 and 47 illustrate the LPM material 1020 applied to the printed circuit board 1018. As illustrated, the LPM material 1020 surrounds but does not encapsulate, for example, the battery strap holes 1026 and the ends of the battery straps 1032 that extend through the battery strap holes 1026 or the battery pack terminals 1022 or the fuses 1034 or the test points 1024. The adhesion holes 1030 are positioned along the boundary or border of the LPM material 1020 around the various exposed components. The positioning (positions) of the adhesion holes 1030 enables the LPM material 1020 to flow through the printed circuit board 1018 at the boundary of the LPM material 1020. This enables the LPM material 1020 to grab or adhere to the printed circuit board 1018. The improved adhesion of the LPM material 1020 to the printed circuit board 1018 prevents water and other debris from penetrating or infiltrating between the LPM material 1020 and the printed circuit board 1018. This prevents the water or other debris from contaminating any components encapsulated by the LPM material 1020.

The plurality of adhesion holes 1030 in the printed circuit board 1018 allow LPM material 1020 to pass from a first side of the printed circuit board 1018 to a second side of the printed circuit board 1018. In other words, the LMP material is able to wrap or grab the printed circuit board 1018 for improved adhesion. Providing an array of periodic adhesion holes 1030 along the boundaries or edges of the LPM material 1020 improves adhesion of the LPM material 1020 to printed circuit board 1018.

In one embodiment, the adhesion holes 1030 have a diameter in the range of approximately 0.5 mm to approximately 2 mm. In another embodiment, the adhesion holes 1030 have a diameter of approximately 1 mm. In one embodiment, the distance between edges of adjacent adhesion holes 1030 is in a range of approximately 1 mm to approximately 3 mm. In another embodiment, the distance between adjacent edges of adjacent adhesion holes 1030 is approximately 2 mm.

The present patent application and its various embodiments as described above uniquely address the observed, noted and researched findings and improve on the prior and current state of the art systems. The listed products, features and embodiments as described in the present patent application should not be considered as limiting in any way.

Although the present patent application has been described in detail for the purpose of illustration, it is to be understood that such detail is solely for that purpose and that the present patent application is not limited to the disclosed embodiments, but, on the contrary, is intended to cover modifications and equivalent arrangements that are within the spirit and scope of the appended claims. In addition, it is to be understood that the present patent application contemplates that, to the extent possible, one or more features of any embodiment can be combined with one or more features of any other embodiment.

The illustration of the embodiments of the present patent application should not be taken as restrictive in any way since a myriad of configurations and methods utilizing the present patent application can be realized from what has been disclosed or revealed in the present patent application. The systems, features and embodiments described in the present patent application should not be considered as limiting in any way. The illustrations are representative of possible construction and mechanical embodiments and methods to obtain the desired features. The location and/or the form of any minor design detail or the material specified in the present patent application can be changed and doing so will not be considered new material since the present patent application covers those executions in the broadest form.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Terms of degree such as “generally,” “substantially,” “approximately,” and “about” may be used herein when describing the relative positions, sizes, dimensions, or values of various elements, components, regions, layers and/or sections. These terms mean that such relative positions, sizes, dimensions, or values are within the defined range or comparison (e.g., equal or close to equal) with sufficient precision as would be understood by a person of ordinary skill in the art in the context of the various elements, components, regions, layers and/or sections being described.

The foregoing illustrated embodiments have been provided to illustrate the structural and functional principles of the present patent application and are not intended to be limiting. To the contrary, the present patent application is intended to encompass all modifications, alterations and substitutions within the spirit and scope of the appended claims.

What is claimed is:

1. A battery pack, comprising:
a module holder; and
a plurality of core pack modules held in the module holder.

2. The battery pack of claim 1, wherein the module holder includes a base and a set of opposing side walls that form an interior storage space that is configured to receive the plurality of core pack modules,
wherein the module holder has a longitudinal axis along a length of the module holder and a first transverse axis and a second transverse axis that are perpendicular to the longitudinal axis, the first transverse axis being along a width of the module holder, the second transverse axis being along a depth of the module holder, and
wherein the set of opposing side walls extend along the longitudinal axis of the module holder.

3. The battery pack of claim 2, wherein the base and the set of opposing side walls of the module holder are integrally formed, and
wherein the set of opposing side walls of the module holder extends perpendicular to the base.

4. The battery pack of claim 2, wherein the set of opposing side walls is a first set of opposing side walls;
wherein the module holder further comprising a second set of opposing side walls; and
wherein the second set of opposing side walls extend along the first transverse axis of the module holder.

5. The battery pack of claim 4, wherein the base, the first set of opposing side walls, and the second set of opposing side walls are integrally formed, and
wherein the first set of opposing side walls and the second set of opposing side walls extend perpendicular to the base.

6. The battery pack of claim 2, wherein each core pack module includes a plurality of battery cells; and
wherein each battery cell of the core pack module extends along the second transverse axis of the module holder.

7. The battery pack of claim 2, wherein each core pack module includes a plurality of battery cells that are configured to be held in relative position to each other.

8. The battery pack of claim 2, wherein at least one of the plurality of core pack modules is configured to be positioned to be parallel to the first transverse axis of the module holder.

9. The battery pack of claim 8, wherein the at least one of the plurality of core pack modules is configured to be positioned to be perpendicular to at least one other of the plurality of core pack modules.

10. The battery pack of claim 2, wherein at least two of the plurality of core pack modules are configured to be positioned to be parallel to each other.

11. The battery pack of claim 10, wherein the at least two of the plurality of core pack modules are configured to be positioned to be parallel to the longitudinal axis of the module holder.

12. The battery pack of claim 1, further comprising a housing wherein the housing includes a first housing portion and a second housing portion together forming an internal cavity;
wherein the plurality of core pack modules is received in the internal cavity of the housing.

13. The battery pack of claim 12, wherein one of the first housing portion and the second housing portion forms the module holder.

14. The battery pack of claim 1, wherein the plurality of core pack modules include three core pack modules.

15. The battery pack of claim 2, further comprising:
an electronics module subassembly configured to be positioned parallel to the base of the module holder, and
a set of battery pack terminals fixedly held in place on the electronics module subassembly, the set of battery pack terminals configured to mate with a corresponding set of terminals of an electrical device,
wherein the electronics module subassembly is configured to be connected with the plurality of core pack modules so as to electrically connect the plurality of core pack modules to the battery pack terminals.

16. The battery pack of 15, wherein the electronics module subassembly is configured to be removably connected to portions of the plurality of core pack modules when the plurality of core pack modules are received in the interior storage space of the module holder.

17. The battery pack of claim 15, wherein the electronics module subassembly includes a printed circuit board.

18. A battery pack, comprising:
a plurality of core pack modules, each module having five sets of battery cells, the five sets of battery cells connected in series to each other, the core pack modules of the plurality of core pack modules are connected in series with each other.

19. The battery pack, as recited in claim 18, wherein each set of battery cells contains at least one battery cell.

20. The battery pack, as recited in claim 18, wherein each set of battery cells contains at least three battery cells.

21. The battery pack, as recited in claim 20, wherein the at least three battery cells of each set of battery cells are connected in parallel.

22. The battery pack, as recited in claim 18, further comprising a printed circuit board, each core pack module of the plurality of core pack modules electrically connected in series to each other through the printed circuit board.

23. A battery pack of claim 1, wherein each of the core pack modules of the plurality of core pack modules are identical, each core pack module being a discrete assembly including a plurality of battery cells and a battery cell holder.
